(19) United States
(12) Patent Application Publication
(10) Pub. No.: US 2016/0196488 A1
(43) Pub. Date: Jul. 7, 2016

(54) NEURAL NETWORK COMPUTING DEVICE, SYSTEM AND METHOD

(71) Applicant: Byungik AHN, Seoul (KR)

(72) Inventor: Byungik AHN, Seoul (KR)

(21) Appl. No.: 14/909,338

(22) PCT Filed: Jul. 31, 2014
(86) PCT No.: PCT/KR2014/007065

§ 371 Date: Feb. 1, 2016

(30) Foreign Application Priority Data
Aug. 2, 2013 (KR) 10-2013-0091855
Jul. 4, 2014 (KR) 10-2014-0083688

(51) Int. Cl. G06N 3/063; G06F 3/06

(52) U.S. Cl. CPC G06N 3/063; G06F 3/0604; G06F 3/0629; G06F 3/0683

(57) ABSTRACT

A neural network computing device, system and method that operate with a synchronization circuit in which all components are synchronized with a system clock and include a distributed memory structure for storing artificial neural network data and a calculation structure for time-division processing of all neurons on a pipeline circuit. The neural network computing device may include: a control unit for controlling the neural network computing device; a plurality of memory units for outputting an output value of a front-end neuron of a connection line by using a dual port memory; and a calculation sub-system for calculating an output value of a rear-end neuron of a new connection line by using the output value of the front-end neuron of the connection line input from each of the plurality of memory units and for feeding the output value back to each of the plurality of memory units.

### BACKGROUND OF THE INVENTION

1. Field of the Invention

Some embodiments of the present invention relate to a digital neural network computing technology field, and more particularly, to a neural network computing device and system, wherein all elements operate as a synchronized circuit synchronized with a single system clock and a distributed memory structure for storing artificial neural network data and a calculation structure for processing all neurons in a time-division way in a pipeline circuit are included, and a method therefor.

2. Description of Related Art

A digital neural network computer is an electronic circuit implemented with the purpose of implementing a function similar to the role of the brain by simulating a biological neural network.

In order to artificially implement a biological neural network, operation methods are suggested in various forms. The configuration methodology of such an artificial neural network is referred to as a neural network model. In most of neural network models, artificial neurons are connected by synapses having directivity, thus forming a network. Signals inputted from the output of a pre-synaptic neuron, connected to a synapse, to the synapse are summed in a dendrite and processed in the cell body (soma) of the neuron. Each neuron has a unique state value and attribute value. The soma of the neuron updates the state value of a post-synaptic neuron based on the input from the dendrite and calculates a new output value. The output value is transferred through the input synapses of a plurality of other neurons, thus affecting neighboring neurons. Each of synapses between neurons may have a plurality of unique state values and attribute values and basically functions to control the intensity of a signal transferred by another synapse. The state value of a synapse, which is most commonly used in most of neural network models, is a weight value indicative of the synaptic strength of the synapse.

A state value means a value that is varied during calculation after it is initially set. An attribute value means a value that is not varied once it is set. For convenience sake, the state value and attribute value of a synapse is collectively named a synapse-specific value, and the state value and attribute value of a neuron is collectively named a neuron-specific value.

Unlike in the biological neural network, in the digital neural network computer, the value of a neuron cannot be changed linearly. Accordingly, a method for calculating the value of each of all neurons once and incorporating a resulting value into next calculation is performed. A cycle in which the values of all neurons are calculated once is referred to as a neural network update cycle. The digital artificial neural network is performed in such a way as to repeatedly execute the neural network update cycle. The method for incorporating the results of the calculation of neurons into next calculation is divided into a non-overlapping update method for incorporating the results of the calculation of all neurons into a next cycle after the calculation of all the neurons and an overlapping update method for sequentially incorporating the results of calculation into all neurons on a specific time within a specific update cycle.

In most of neural network models, the calculation of the new output value of a neuron may be represented by an equation generalized like [Equation 1] below.

yᵢ(T+1)=f_{N}(SNⱼ,Σᵢ^{v}^{ⱼ}fₛ(SSᵢⱼ,y_{M}_{ᵢⱼ}(T))) [Equation 1]

In Equation 1, yⱼ(T) is the output value of a neuron j calculated in a T-th neural network update cycle, f_{N} is a neuron function for updating a plurality of state values of the neuron and calculating a single new output value, fₛ is a synapse function for updating a plurality of state values of a synapse and calculating a single output value, SNⱼ is a set of state values and attribute values of a plurality of specific neurons j, SSᵢⱼ is a set of a plurality of specific state values and attribute values of the i-th synapse of the neuron j, pⱼ is the number of input synapses of the neuron j, and Mᵢⱼ is the reference number of a neuron connected to the i-th input synapse of the neuron j.

In most of conventional neural network models, however, the value of a neuron is represented in a single real number or integer and calculated as in [Equation 2] below.

yᵢ(T+1)=f[Σᵢ₌₁^{P}^{ⱼ}ωᵢⱼ·y_{Mij}(T)] [Equation 2]

In Equation 2, wᵢⱼ is the weight value of the i-th input synapse of a neuron j. [Equation 2] is one of some cases of [Equation 1]. In [Equation 1], SSᵢⱼ is the weight value of a single synapse, and the synapse function fₛ is a calculation equation for multiplying the weight value Wᵢⱼ and an input value y_{Mij}.

Meanwhile, in a spiking neural network model operating like the neural network of a biological brain, a neuron sends an instant spike signal. The spike signal is delayed for some time depending on the unique attribute value of a synapse before it is transferred to the synapse. The synapse that has received the delayed spike signal generates signals in various patterns. A dendrite sums the signals and transfers the summed result as the input of a soma. The soma updates its state value using the input signal and the state values of a plurality of neurons as factors and outputs a single spike signal as output if a specific condition is satisfied. In such a spiking neural network model, a synapse may have several state values and attribute values in addition to the weight value of the synapse and may include a specific calculation equation depending on a neural network model. A neuron may also have one or a plurality of state values and attribute values, and may be calculated using a specific calculation equation depending on a neural network model. For example, in an “Izhikevich” model, a single neuron may have two state values and four attribute values and reproduce various spiking patterns like a biological neuron based on the attribute values.

A model of such spiking neural network models, such as a biology-realistic Hodgkin-Huxley (HH) model, has a disadvantage in that a computational load becomes excessive because over 240 operators need to be calculated in order to calculate a single neuron and a neural network update cycle also needs to be calculated every cycle corresponding to 0.05 ms of a biological neuron.

Neurons within an artificial neural network may be classified into input neurons for receiving input values from the outside, output neurons functioning to transfer processed results to the outside, and the remaining hidden neurons.

In a multi-layer network including a plurality of layers, an input layer formed of an input neuron, one or a plurality of hidden layers, and an output layer formed of an output neuron are continuously connected, and the neurons of one layer are connected by only the neurons of a next layer.

In general, in order for an artificial neural network to derive a preferred result value, knowledge information is stored in the neural network in the form of a synapse weight value. A step for adjusting the synapse weight value of an artificial neural network and accumulating knowledge is referred to as learning mode, and a step for searching for stored knowledge by presenting input data is referred to as recall mode.

In learning mode, the weight value of a synapse in addition to the state value and output value of a neuron is also updated in a single neural network update cycle.

The most common learning methods include methods derived from Hebbian theory. Simply expressed, Hebbian theory is a theory in which the strength of a synapse of a neural network is enhanced when both the output value of a pre-synaptic neuron connected to the synapse as an input and the value of a post-synaptic neuron that receives the input through the synapse are strong, but the strength of a synapse of a neural network is gradually weakened when both the output value of a pre-synaptic neuron connected to the synapse as an input and the value of a post-synaptic neuron that receives the input through the synapse are not strong. If the learning method is generalized, it may be represented as in [Equation 3] below.

Wᵢⱼ=Wᵢⱼ+Y_{Mij}*Lⱼ [Equation 3]

In Equation 3, Lⱼ is a value calculated by the equation for calculating the state value and output value of a neuron j and is referred to as a learning state value, for convenience sake. The learning state value is characterized in that it includes only a neuron-specific value other than a synapse-specific value. For example, a typical Hebbian learning rule is defined as in [Equation 4] below.

Wᵢⱼ=Wᵢⱼ+Y_{Mij}*η*Yⱼ [Equation 4]

In Equation 4, η is a constant value that controls learning speed. In [Equation 4], a learning state value Lⱼ is η*yⱼ. In addition to the Hebbian learning rule, a delta learning rule or Spike Timing Dependant Plasticity (STDP) chiefly used in the following spiking neural network belong to the category of the methods derived from Hebbian theory.

A method that is most frequently used in learning in the neural network model of the multi-layer network is a back-propagation algorithm. The back-propagation algorithm is a supervised learning method for assigning, by a supervisor outside a system, the most preferred output value corresponding to a specific input value, that is, a learning value, in learning mode. The back-propagation algorithm includes sub-cycles, such as 1 to 5 below, in a single neural network update cycle.

1. A first sub-cycle in which an input value is assigned to each of the input neurons of an input layer

2. A second sub-cycle in which the new output value of a neuron is calculated forward from a hidden layer, connected to the input layer, to an output layer

3. A third sub-cycle in which the error value of an output neuron is calculated based on an externally provided learning value and the newly calculated output value of the neuron with respect to each of all the neurons of the output layer

4. A fourth sub-cycle in which an error value backward calculated in the third sub-cycle from a hidden layer connected to the output layer to the hidden layer connected to the input layer is propagated so that all hidden neurons have the error value. In this case, the error value of the hidden neuron is calculated as the sum of the error values of neurons that are backward connected.

5. A fifth sub-cycle in which the weight value of a synapse is adjusted based on the output value of a pre-synaptic neuron connected to each synapse and a learning state value Lⱼ into which the error value of a post-synaptic neuron has been incorporated with respect to each of the synapses of all the hidden neurons and output neurons. In this case, a calculation equation for calculating the learning state value Lⱼ may be different depending on various methods even within the back-propagation algorithm.

The back-propagation algorithm is characterized in that data flows forward and backward in the neural network and at this time, the weight value of a synapse is shared between the forward and backward directions.

However, the back-propagation algorithm has a limit to an increase of its performance although the number of layers is increased. There is a deep relief network as a neural network model that overcomes the limit and that has recently been in the spotlight. The deep relief network has a network in which a plurality of Restricted Boltzmann Machines (RBMs) is continuously connected. In this case, each of the RBMs has a network structure in which it includes n visible layer neurons and m hidden layer neurons with respect to a specific number n, m and all the neurons of each layer are never connected to the neurons of the same layer, but are connected to all the neurons of another layer. In learning calculation in the deep relief network, the value of a neuron of a visible layer in the foremost RBM is designated as the value of learning data, the value of a synapse is adjusted by executing an RBM learning procedure, the new value of a hidden layer is derived, and the value of a neuron of a hidden layer in a previous-stage RBM becomes the input value of the visible layer of a next-stage RBM. Accordingly, all the RBMs are sequentially calculated. Learning calculation in the deep relief network is performed in such a way as to adjust the weight value of a synapse by repeatedly applying several learning data, and a calculation procedure for learning a single learning datum is as follows.

1. Learning data is designated as the value of a visible layer neuron in the foremost RBM. Furthermore, the following process 2 to process 5 are sequentially repeated from the foremost RBM.

2. Assuming that the vector of the value of the visible layer neuron is vpos, the values of all the neurons of a hidden layer are calculated using vpos as an input, and the vector of the values of all the neurons of the hidden layer is referred to as hpos. The vector hpos becomes the output of the RBM. (RBM-first step)

3. The values of all the neurons of the visible layer are calculated using the vector hpos as an input by applying a back-propagation network, and a corresponding vector is referred to as vneg. (RBM-second step)

4. The values of the neurons of the hidden layer are calculated again using the vector vneg as an input, and a corresponding vector is referred to as hneg. (RBM-third step)

5. Assuming that the element of vpos of a visible layer neuron connected to each synapse is vposᵢ, the element of vneg is vnegᵢ, the element of hpos of a hidden layer neuron connected to the synapse is hposⱼ, and the element of hneg is hneg, with each of all synapses, the synapse is added by a value proportional to (vposᵢ*hposᵢ−vnegᵢ*hnegⱼ).

Such a deep relief network is disadvantageous in it is difficult to implement the deep relief network in hardware because the deep relief network requires a great computational load and calculation processes are many and complicated, calculation speed is slow because the deep relief network has to be processed in software, and low-power and real-time processing are not easy.

The neural network computer is used for pattern reorganization for searching for a pattern most suitable for a given input or is used to predict the future based on intuitive knowledge, and it may be used in various fields, such as robot control, military equipment, medicines, gaming, weather information processing, and human-machine interfaces.

An existing neural network computer is basically divided into a direct implementation method and a virtual implementation method. The direct implementation method is an implementation method for mapping the logical neurons of an artificial neural network to physical neurons in a 1-to-1 way. Most of analog neural network chips belong to the category of the direct implementation method. Such a direct implementation method may have fast processing speed, but has a disadvantage in that it is difficult to apply a neural network model to the direct implementation method in various ways and it is difficult to apply the direct implementation method to a large-scale neural network.

The virtual implementation method is a method using most of existing von Neumann type computers or using a multi-processor system in which such computers are connected in parallel, and it may execute various neural network models and large-scale neural networks, but has a disadvantage in that it is difficult to obtain high speed.

### SUMMARY OF THE INVENTION

As described above, the conventional direct implementation method may have fast processing speed, but is problematic in that a neural network model cannot be applied to the direct implementation method in various ways and the direct implementation method cannot be applied to a large-scale neural network. The conventional virtual implementation method may execute various neural network models and large-scale neural networks, but is problematic in that it is difficult to obtain high speed. One of the objects of the present invention is to solve such problems.

Embodiments of the present invention provide a neural network computing device and system, wherein all elements operate as a synchronized circuit synchronized with a single system clock and a distributed memory structure for storing artificial neural network data and a calculation structure for processing all neurons in a time-division way in a pipeline circuit are included, and a method therefor.

A neural network computing device in accordance with an embodiment of the present invention may include a control unit for controlling the neural network computing device; a plurality of memory units each for outputting an output value of a pre-synaptic neuron using dual port memory; and a single calculation sub-system for calculating an output value of a new post-synaptic neuron using the output values of the pre-synaptic neurons received from the plurality of memory units and feeding the new output value back to each of the plurality of memory units.

A neural network computing system in accordance with an embodiment of the present invention may include a control unit for controlling the neural network computing system; a plurality of network sub-systems each including a plurality of memory units each for outputting an output value of a pre-synaptic neuron using dual port memory; and a plurality of calculation sub-systems each for calculating an output value of a new post-synaptic neuron using the output values of the pre-synaptic neurons received from a plurality of the memory units included in one of the plurality of network sub-systems and feeding the new output value back to each of the plurality of memory units.

A multi-processor computing system in accordance with an embodiment of the present invention may include a control unit for controlling the multi-processor computing system and a plurality of processor sub-systems each for calculating some of a computational load and outputting some of the results of the calculation in order to share some of the results with another processor. Each of the plurality of processor sub-systems may include a single processor for calculating some of the computational load and outputting some of the results of the calculation in order to share some of the results with another processor and a single memory group for performing a communication function between the processor and another processor.

A memory device in accordance with an embodiment of the present invention may include first memory for storing the reference number of a pre-synaptic neuron and second memory including dual port memory having a read port and a write port, for storing an output value of a neuron.

A neural network computing method in accordance with an embodiment of the present invention includes the steps of outputting, by each of a plurality of memory units, an output value of a pre-synaptic neuron using dual port memory under a control of a control unit and calculating, by a single calculation sub-system, an output value of a new post-synaptic neuron using the output values of the pre-synaptic neuron received from the plurality of memory units, respectively, under the control of the control unit and feeding the new output value back to each of the plurality of memory units. The plurality of memory units and the single calculation sub-system operate in a pipeline way in synchronization with a single system clock under the control of the control unit.

### BRIEF DESCRIPTION OF THE DRAWINGS

FIG. 1 is a diagram showing the configuration of a neural network computing device in accordance with an embodiment of the present invention.

FIG. 2 shows a detailed configuration of a control unit in accordance with an embodiment of the present invention.

FIG. 3 is an exemplary diagram of a neural network showing a flow of neurons and data in accordance with an embodiment of the present invention.

FIGS. 4a and 4b are diagrams for illustrating a method for distributing and storing the reference numbers of pre-synaptic neurons in memory M in accordance with an embodiment of the present invention.

FIG. 5 is a diagram showing a flow of data performed in response to a control signal in accordance with an embodiment of the present invention.

FIG. 6 is a diagram showing a dual memory swap circuit in accordance with an embodiment of the present invention.

FIG. 7 is a diagram showing the configuration of a calculation sub-system in accordance with an embodiment of the present invention.

FIG. 8 is a diagram showing the configuration of a synapse unit supporting a spiking neural network model in accordance with an embodiment of the present invention.

FIG. 9 is a diagram showing the configuration of a dendrite unit in accordance with an embodiment of the present invention.

FIG. 10 is a diagram showing the configuration of one piece of attribute value memory in accordance with an embodiment of the present invention.

FIG. 11 is a diagram showing the structure of a system using a multi-time scale method in accordance with an embodiment of the present invention.

FIG. 12 is a diagram showing a structure for calculating a neural network using a learning method, such as that described in [Equation 3], in accordance with an embodiment of the present invention.

FIG. 13 is a diagram showing a structure for calculating a neural network using a learning method in accordance with another embodiment of the present invention.

FIG. 14 is an exemplary diagram of a memory unit in accordance with an embodiment of the present invention.

FIG. 15 is another exemplary diagram of a memory unit in accordance with an embodiment of the present invention.

FIG. 16 is yet another exemplary diagram of a memory unit in accordance with an embodiment of the present invention.

FIG. 17 is an exemplary diagram of a neural network computing system in accordance with an embodiment of the present invention.

FIG. 18 is a diagram for illustrating a method for generating a memory control signal in the control unit in accordance with an embodiment of the present invention.

FIG. 19 is a diagram showing the configuration of a multi-processor computing system in accordance with another embodiment of the present invention.

FIGS. 20a to 20c are diagrams for illustrating the results obtained by representing a synapse function in assembly code and designing the assembly code according to a design procedure in accordance with an embodiment of the present invention.

### DESCRIPTION OF SPECIFIC EMBODIMENTS

In describing the present invention, a detailed description of a known art related to the present invention will be omitted if it is deemed to make the gist of the present invention unnecessarily vague. The most preferred embodiment of the present invention will now be described in detail with reference to the accompanying drawing to the extent that those skilled in the art may easily practice the technical spirit of the present invention.

Furthermore, throughout this specification, when it is described that one part is “connected” to the other part, the one part may be “directly connected” to the other part or “electrically connected” to the other part through a third element. Furthermore, when it is described that any part “includes” or “comprises” any element, it means the part does not exclude other elements, but may further include or comprise other elements, unless specially defined otherwise. Furthermore, in the description of the entire specification, even if some elements have been described in the singular form, the present invention is not limited thereto and it may be understood that a corresponding element may be plural.

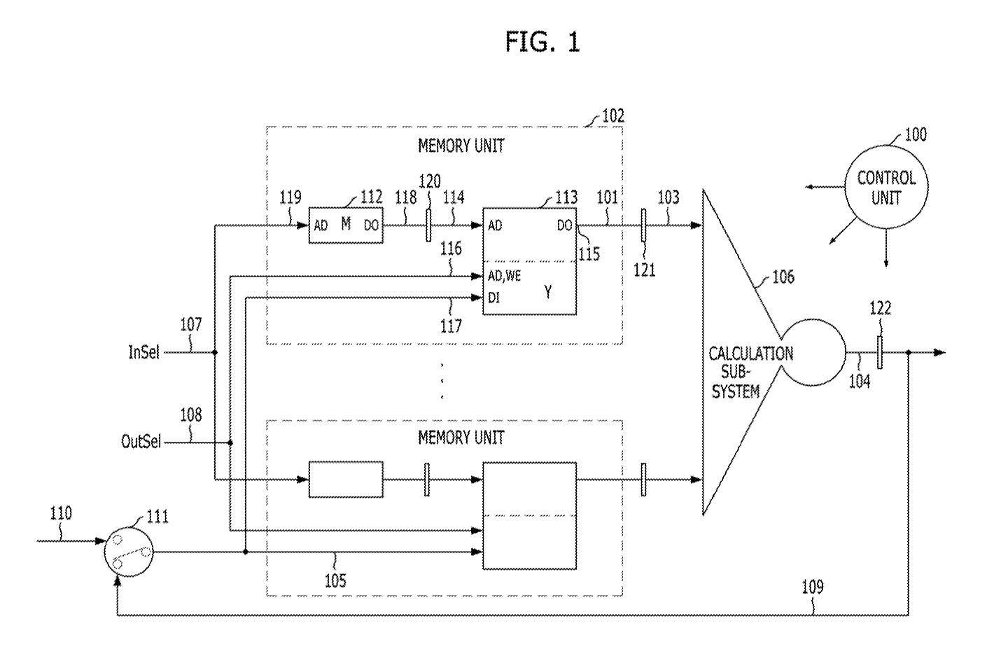

FIG. 1 is a diagram showing the configuration of a neural network computing device in accordance with an embodiment of the present invention and shows a basic detailed structure of the neural network computing device.

As shown in FIG. 1, the neural network computing device in accordance with an embodiment of the present invention includes a control unit 100 for controlling the neural network computing device, a plurality of memory units 102 each for outputting (101) the output value of the pre-synaptic neuron of a synapse, and a single calculation sub-system 106 for calculating the output value of a new post-synaptic neuron using the output values of the pre-synaptic neurons received (103) from the plurality of memory units 102, respectively, and feeding the calculated output value as an input (105) to the plurality of memory units 102 through an output 104.

In this case, an InSel input (a synapse bundle number 107) and an OutSel input (an address at which a newly calculated neuron output value will be stored and a write enable signal 108) connected to the control unit 100 are connected to the plurality of all the memory units 102 in common. The outputs 101 of the plurality of memory units 102 are connected to the inputs of the calculation sub-system 106. Furthermore, the output (the output value of a post-synaptic neuron) of the calculation sub-system 106 is connected to the inputs of the plurality of all the memory units 102 through a “HILLOCK” bus 109.

A digital switch (e.g., a multiplexer 111) for selecting one of a line 110 through which the value of an input neuron from the control unit 100 is received and the “HILLOCK” bus 109 through which the output value of a post-synaptic neuron newly calculated in the calculation sub-system 106 is output under the control of the control unit 100 and for connecting the selected line or bus to the memory units 102 may be further included between the output 104 of the calculation sub-system 106 and the inputs 105 of the plurality of all the memory units 102. Furthermore, the output 104 of the calculation sub-system 106 is connected to the control unit 100, and it transfers the output value of a neuron to the outside.

Each of the memory units 102 includes memory M (first memory 112) for storing the reference number (the address value of memory Y (second memory 113) in which the output value of a neuron has been stored) of a pre-synaptic neuron and the memory Y for storing the output value of the neuron. The memory Y 113 consists of dual port memory having two ports of a read port 114, 115 and a write port 116, 117. The data output (DO) 118 of the first memory is connected to the address input (AD) 114 of the read port. The data output 115 of the read port is connected to the output 101 of the memory unit 102. The data input (DI) 117 of the write port is connected to the input 105 of the memory unit 102 and connected to the inputs of other memory units in common. Furthermore, the address inputs (AD) 119 of the memory M 112 of all the memory units 102 are bound in common and connected to the InSel input 107. The address input 116 and write enable (WE) 116 of the write port of the memory Y 113 are connected to the OutSel input 108 in common and are used to store the output value of a neuron. Accordingly, the memory Y 113 of all the memory units 102 has the output values of all neurons as the same contents.

A first register 120 (temporarily stores the reference number of a pre-synaptic neuron output by the memory M) may be further included between the data output 118 of the memory M 112 of the memory unit 102 and the address input of the read port 114 of the memory Y 113. All the first registers 120 are synchronized with a single system clock so that the read ports 114 and 115 of the memory M 112 and memory Y 113 operate in a pipeline way under the control of the control unit 100.

Furthermore, a plurality of second registers 121 (each temporarily stores the output value of a pre-synaptic neuron from the memory Y) may be further included between the respective outputs 115 of the plurality of all the memory units 102 and the input 103 of the calculation sub-system 106. Furthermore, a third register 122 (temporarily stores the new output value of a neuron output by the calculation sub-system) may be further included in the output stage 104 of the calculation sub-system 106. The second and the third registers 121 and 122 are synchronized with a single system clock so that the plurality of memory units 102 and the single calculation sub-system 106 operate in a pipeline way under the control of the control unit 100.

As a method for operating the neural network computing device in order to calculate a known artificial neural network, the neural network computing device distributes and stores the reference numbers of pre-synaptic neurons, connected to the input synapses of all neurons within the artificial neural network, in the memory M 112 of the plurality of memory units 102 and performs a calculation function in accordance with the following step a to step d.

a. The step of sequentially changing the value of the InSel input 107, transferring the changed value to the address inputs 119 of the memory M 112 of the plurality of memory units 102, and sequentially outputting the reference numbers of pre-synaptic neurons, connected to the input synapses of neurons, to the data outputs 118 of the memory M 112

b. The step of sequentially outputting the output values of the pre-synaptic neurons, connected to the input synapse of a neuron, to the data outputs 115 of the read ports of the memory Y 113 of the plurality of memory units 102 so that the output values are inputted as the inputs 103 of the calculation sub-system 106 through the outputs 101 of the memory unit 102

c. The step of updating, by the calculation sub-system 106, the state value of a post-synaptic neuron and sequentially calculating the output value of the post-synaptic neuron

d. The step of outputting the output value of the post-synaptic neuron, calculated by the calculation sub-system 106, through an output 104 and then sequentially storing the output value through the inputs 105 of the plurality of memory units 102 and the write ports 117 of the memory Y 113

In this case, the method for distributing and storing, by the neural network computing device, the reference numbers of pre-synaptic neurons, connected to the input synapses of all neurons within the artificial neural network, in the memory M 112 of the plurality of memory units 102 may be performed in accordance with the following process a to process f.

a. The process of searching the neural network for the number Pmax of input synapses of a neuron having the greatest number of input synapses

b. The process of adding a virtual synapse which has no influence on adjacent neurons although any neuron is connected to each neuron so that all the neurons within the neural network have synapses of ┌Pmax/p┐*p, assuming that the number of memory units 102 is p

c. The process of aligning all the neurons within the neural network in specific order and assigning serial numbers to the neurons

d. The process of classifying the synapses of all the neurons into ┌Pmax/p┐ bundles by dividing the synapses by p and aligning the bundles in specific order

e. The process of sequentially assigning serial numbers k to the bundles from the first synapse bundle of the first neuron to the last synapse bundle of the last neuron

f. The process of storing the value of the reference number of a pre-synaptic neuron, connected to the i-th synapse of a k-th synapse bundle, in the k-th address of the memory M 112 of the i-th memory unit of the memory units 102

The write ports 116, 117 of the memory Y 113 of the plurality of memory units 102 are connected to the write ports of the memory Y of all other memory units in common. Accordingly, the same contents are stored in all the pieces of the memory Y 113, and the output value of an i-th neuron is stored in an i-th address.

After the initial value is stored in the memory as described above, a more detailed method for operating the system is as follows. When a neural network update cycle is started, the control unit 100 supplies the InSel input 107 with the number value of a synapse bundle, which increases by 1 every system clock cycle starting from 1. After a lapse of a specific system clock cycle since the neural network update cycle is started, the output values of the pre-synaptic neurons of all synapses included in a specific synapse bundle are sequentially output to the outputs 115 of the plurality of memory units 102 every system clock cycle. Order of the synapse bundles sequentially output as described above is repeated from the first synapse bundle of a neuron No. 1 to the last synapse bundle and from the first synapse bundle of a next neuron to the last synapse bundle. Such order is repeated until the last synapse bundle of the last neuron is output.

Furthermore, the calculation sub-system 106 receives the outputs 101 of the memory units 102 as an inputs and calculates the new state value and output value of a neuron. If each of all neurons has n synapse bundles, the data of the synapse bundles of the neurons is sequentially inputted to the inputs 103 of the calculation sub-system 106 after a lapse of a specific system clock cycle since a neural network update cycle is started. The output value of a new neuron is calculated every n system clock cycles and is output through the output 104 of the calculation sub-system 106.

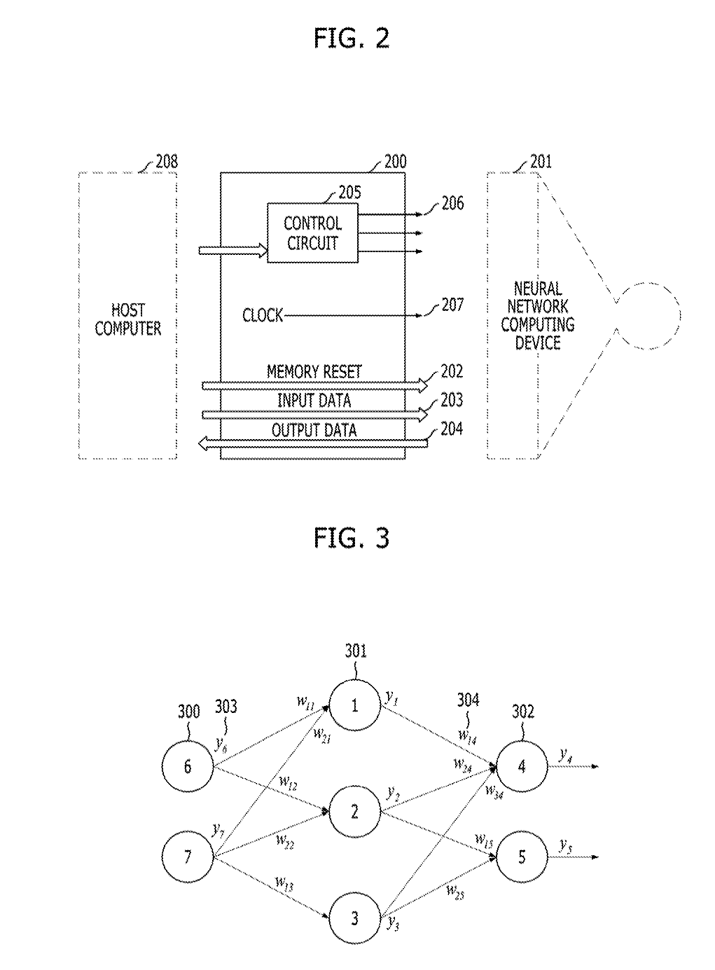

FIG. 2 shows a detailed configuration of the control unit in accordance with an embodiment of the present invention.

As shown in FIG. 2, the control unit 200 in accordance with an embodiment of the present invention provides various control signals to a neural network computing device 201, such as that described in FIG. 1, and performs functions, such as the resetting (202) of each of pieces of memory within a system, the loading (203) of real-time or non-real time input data, and the drawing (204) of real-time or non-real time output data. Furthermore, the control unit 200 may be connected to a host computer 208 and controlled by a user.

In this case, a control circuit 205 provides the neural network computing device 201 with all control signals 206 and clock signals 207 which are required to sequentially process synapse bundles and neurons within a neural network update cycle.

Furthermore, as an alternative to the host computer 208, an embodiment of the present invention may be previously programmed by a microprocessor in a stand-alone way and may be used in application fields for real-time input/output processing.

FIG. 3 is an exemplary diagram of a neural network showing a flow of neurons and data in accordance with an embodiment of the present invention.

The example shown in FIG. 3 includes two input neurons (neurons 6 300 and 7), three hidden neurons (neurons 1 301 to 3), and two output neurons (neurons 4 302 and 5). Each of the neurons has a unique output value 303, and a synapse connecting neurons has a unique weight value 304.

For example, w₁₄ 304 is indicative of the weight value of a synapse connected from the neuron 1 301 to the neuron 4 302. The pre-synaptic neuron of the synapse is the neuron 1 301, and the post-synaptic neuron thereof is the neuron 4 302.

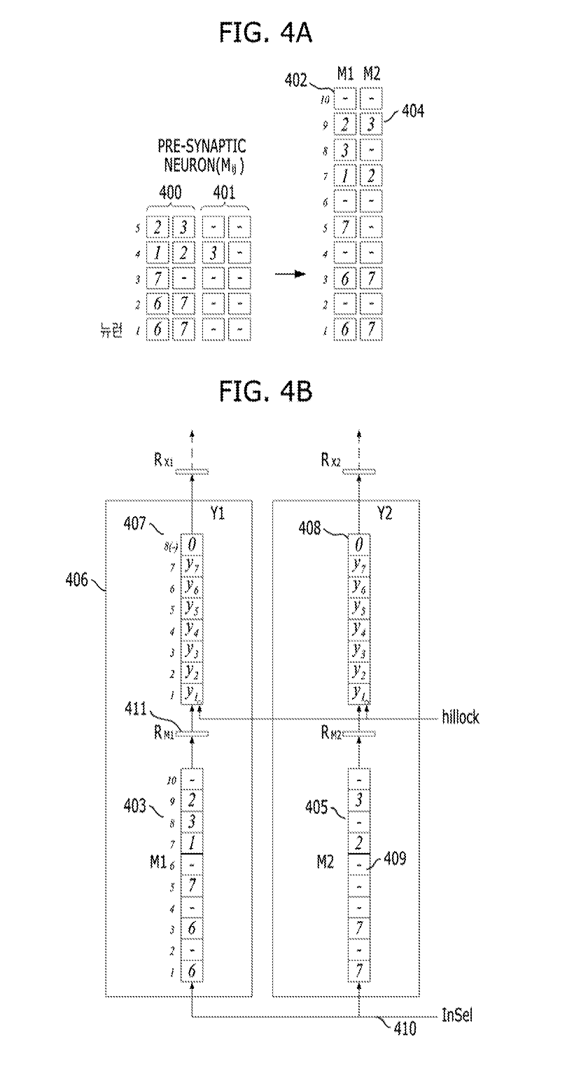

FIGS. 4a and 4b are diagrams for illustrating a method for distributing and storing the reference numbers of pre-synaptic neurons in the memory M in accordance with an embodiment of the present invention. FIGS. 4a and 4b illustrate a method for distributing and storing the reference numbers of pre-synaptic neurons, connected to the input synapses of all the neurons within an artificial neural network, in the memory M 112 of the plurality of memory units 102 in accordance with the aforementioned memory configuration method with respect to the neural network illustrated in FIG. 3.

In the neural network of FIG. 3, a neuron having the greatest number of input synapses is the neuron 4 302, and the number of input synapses is 3 (Pmax=3). Assuming that the number of memory units within the neural network is 2 (p=2), a virtual synapse is added so that each of all the hidden neurons and the output neurons has [3/2]*2=4 synapses (refer to FIG. 4a). For example, in the neuron 5, two virtual neurons 401 are added to two synapses 400. Every four synapses of each of the neurons are aligned in every two bundles in a row (refer to FIG. 4a). In a set of the aligned synapse bundles, a first column 402 is stored as the contents of the memory M 403 of the first memory unit 406, and a second column 404 is stored as the contents of the memory M 405 of the second memory unit.

FIG. 4b is a diagram showing the contents of memory within each of the two memory units. The output value of a neuron is stored in the memory Y 407 of the first memory unit 406. In the embodiment of FIG. 4b, a method for adding a virtual neuron 8 408 always having an output value of 0 to a virtual synapse and connecting the virtual neuron 8 408 to all virtual synapses 409 has been used.

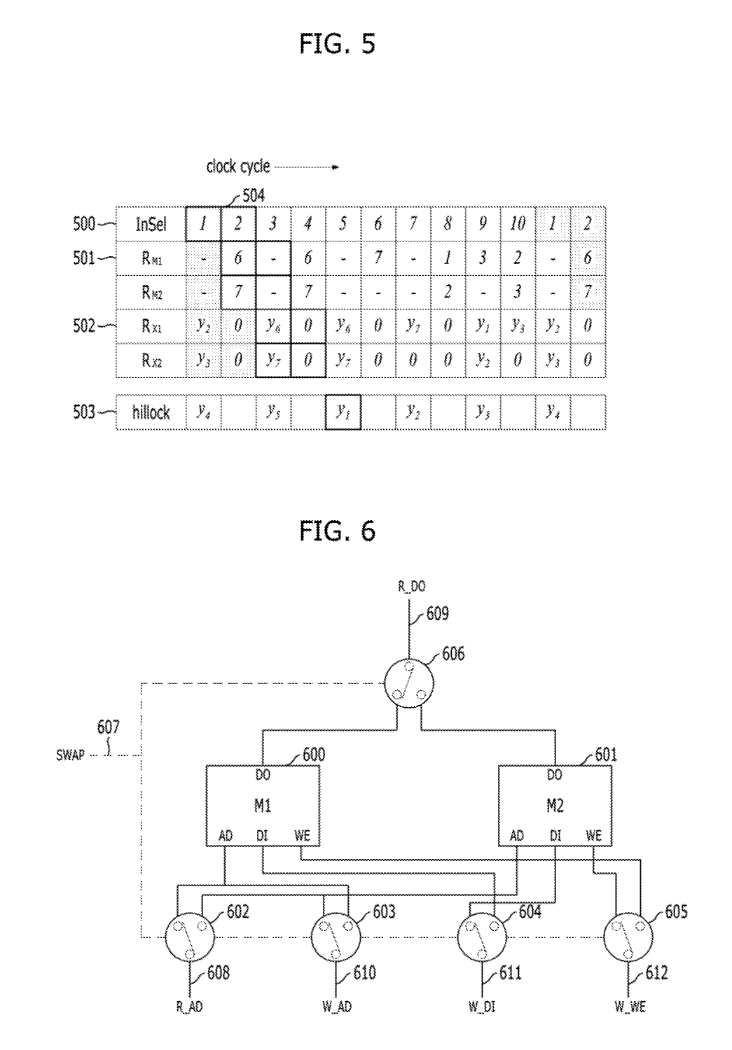

FIG. 5 is a diagram showing a flow of data performed in response to a control signal in accordance with an embodiment of the present invention.

When one neural network update cycle is started, the control unit 100 sequentially inputs unique synapse bundle numbers as the InSel inputs 410, 500. When a k value, that is, a specific synapse bundle number, is provided to the InSel input 500 in a specific clock cycle, the reference number of a neuron connected to the i-th synapse of the k-th synapse bundle as an input is stored in the first register 411, 501 in a next clock cycle.

When the next clock cycle is started, the output value of a neuron connected to the i-th synapse of the k-th synapse bundle as an input is stored in the second register 121, 502 connected to the output 407 of the memory unit 406 and is transferred to the calculation sub-system 106.

The calculation sub-system 106 performs calculation using the input data, sequentially calculates the output value of a new neuron, and outputs the output value. The output value of the new neurons is temporarily stored in the third register 122 and stored in the memory Y 113 as the input 105, 503 of each memory unit 102 through the “HILLOCK” bus 109.

In FIG. 5, a box 504 indicated by a thick line is distinctly indicative of a flow of data of a neuron 1. After all neurons within the neural network are calculated, the one neural network update cycle is terminated, and a next neural network update cycle may be started.

The neural network computing device described in the aforementioned embodiment of the present invention may use the following method as an additional method if a neural network to be calculated is a multi-layer network.

The neural network computing device distributes, accumulates, and stores the reference numbers of neurons included in a corresponding layer, connected to the input synapses of the neurons, in a specific address range of the memory M (the first memory 112) of the plurality of memory units 102, with respect to each of one or a plurality of hidden layers and an output layer, and performs a calculation function in accordance with the following step a and step b.

a. The step of storing input data in the memory Y (the second memory 113) of the plurality of memory units 102 as the value of a neuron of an input layer through the data inputs 117 of the write ports 117

b. The step of sequentially calculating each of the hidden layers and the output layer from a layer, connected to an input layer, to the output layer in accordance with the following process b1 to process b4

b1. The process of sequentially changing the values of the address inputs 119 of the memory M (the first memory 112) of the plurality of memory units 102 within the address range of the corresponding layer and sequentially outputting the reference numbers of neurons, connected to the input synapses of the neurons within the corresponding layer, to the data outputs 118 of the memory M 112

b2. The process of sequentially outputting the output values of the neurons, connected to the input synapses of the neurons within the corresponding layer, to the data outputs 115 of the read ports of the memory Y 113 of the plurality of memory units 102

b3. The process of sequentially calculating, by the calculation sub-system 106, the new output values of all the neurons within the corresponding layer

b4. The process of sequentially storing, by the calculation sub-system 106, the output values of the neurons through the write ports 117 of the memory Y 113 of the plurality of memory units 102 as the output 104 of the calculation sub-system 106 via the “HILLOCK” bus 109

In this case, a method for repeatedly performing the following process a to process f on each of one or a plurality of hidden layers and an output layer within a multi-layer network may be used as a more detailed method for distributing, accumulating, and storing, by the neural network computing device, the reference numbers of neurons in specific address ranges of the memory M 112 of the plurality of memory units 102 in order to calculate the neural network including the multi-layer network.

a. The step of searching a corresponding layer for the number Pmax of input synapse of a neuron having the greatest number of input synapses

b. The process of adding a virtual synapse which has no influence on adjacent neurons although any neuron is connected to each neuron so that all neurons within the corresponding layer have ┌Pmax/p┐*p synapses, assuming that the number of memory units is p

c. The process of aligning the neurons within the corresponding layer in specific order and assigning serial numbers to the neurons

d. The process of classifying the synapses of each neuron within the corresponding layer into ┌Pmax/p┐ bundles by dividing the synapses by p and aligning the bundles in specific order

e. The process of sequentially assigning serial numbers k to the bundles from the first synapse bundle of the first neuron to the last synapse bundle of the last neuron within the corresponding layer

f. The process of storing the value of the reference number of a neuron, connected to the i-th synapse of a k-th synapse bundle, in a k-th address within a specific address area range for the corresponding layer of the first memory of the i-th memory unit of the memory units

In this case, the calculation function is performed using the results of the calculation (the output value of a neuron) of a previous layer from an input layer to the output layer step by step. There is an advantage in that the value of an output neuron corresponding to an input can be calculated in a single neural network update cycle through such a method.

Meanwhile, the dual port memory which is used as the memory Y 113 of the memory unit 112 and which provides the read port and the write port may include physical dual port memory on which logic circuits capable of simultaneously accessing one piece of memory in the same clock cycle have been mounted.

Dual port memory used in the memory Y 113 of the memory unit 112 as an alternative to the physical dual port memory may include two input/output ports for accessing one piece of physical memory in a time-division way in different clock cycles.

Dual port memory used as the memory Y 113 of the memory unit 112 as an alternative to the two types of dual port memory may include two pieces of identical physical memory 600 and 601, as shown in FIG. 6, and it may be implemented as a dual memory swap circuit for changing and connecting all the inputs and outputs of the two pieces of identical physical memory 600 and 601 using a plurality of digital switches 602 to 606 controlled in response to a control signal from the control unit 100.

In the example of FIG. 6, when all the switches 602 to 606 are connected through their left terminals in response to a swap signal 607 from the control unit 100, an R_AD input 608 and an R_DO output 609 forming the read port are connected to the first physical memory 600, and a W_AD input 610, a W_WE input 612, and a W_DI input 611 forming the write port are connected to the second physical memory 601. When the swap signal 607 is changed by the control unit 100, the positions of the two pieces of memory 600 and 601 are changed, and thus the same effect as that in which the contents of the two pieces of memory have been logically changed is obtained.

Such a dual memory swap circuit may be effectively used when the non-overlapping update method for incorporating, by the neural network computing device, the results of calculation into a next cycle after completing the calculation of all neurons is used. That is, if the dual memory swap circuit is used as the memory Y 113 of the memory unit 112, when one neural network update cycle is terminated and the control unit 100 changes the swap signal, contents stored through the write port 116, 117 of the memory Y 113 in a previous neural network update cycle are instantaneously changed to the content of memory which is accessed through the read port 114, 115.

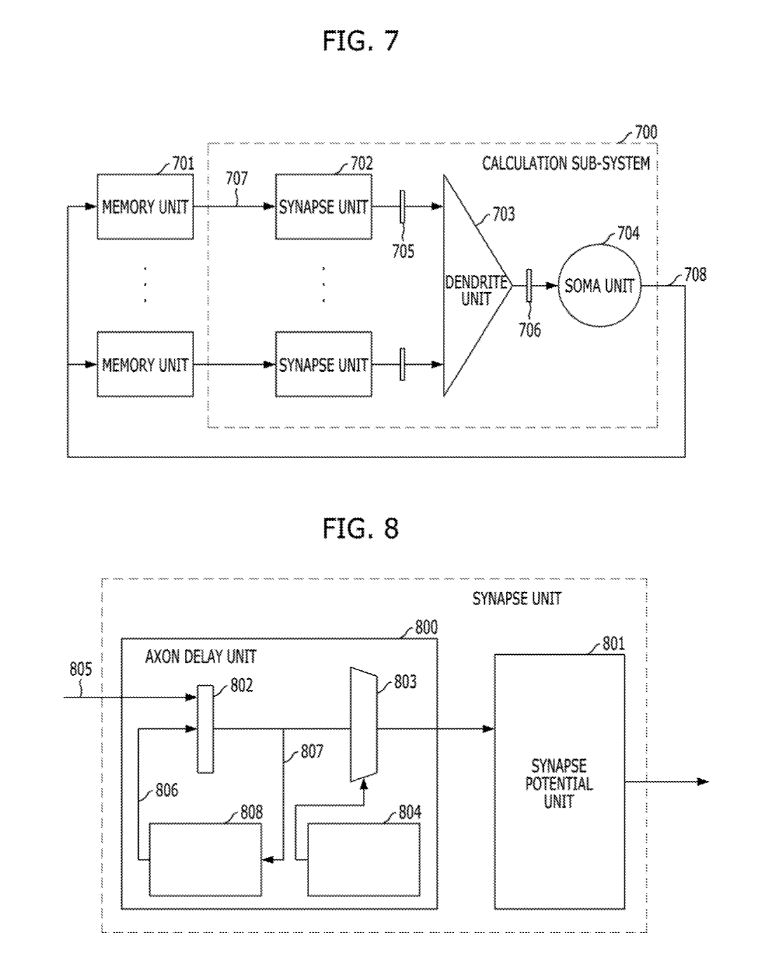

FIG. 7 is a diagram showing the configuration of a calculation sub-system in accordance with an embodiment of the present invention.

As shown in FIG. 7, the calculation sub-system 106, 700 for calculating the output value of a new post-synaptic neuron using the output value of a pre-synaptic neuron received (103) from each of the plurality of memory units 102 and feeding the calculated output value back to the inputs 105 of the plurality of memory units 102 through the output 104 may include a plurality of synapse units 702 for receiving the outputs of a plurality of memory units 701, respectively and performing synapse-specific calculation fₛ, a single dendrite unit 703 for receiving the outputs of the plurality of synapse units 702 and calculating the sum of inputs transferred from all the synapses of a neuron, and a soma unit 704 for receiving the output of the dendrite unit 703, updating the state value of the neuron, calculating a new output value, and outputting the calculated new output value as the output 708 of the calculation sub-system 700.

The internal structure of the synapse unit 702, the dendrite unit 703, and the soma unit 704 may be different depending on a neural network model calculated by the calculation sub-system 700.

The synapse unit 702 which may be differently implemented depending on a neural network model may include a spiking neural network model, for example. As described above, in the spiking neural network model, the output (spike) of a neuron of 1 bit is transferred to the synapse unit, and the synapse unit 702 performs synapse-specific calculation. In this case, the synapse-specific calculation includes an axon delay function for delaying a signal by a specific neural network update cycle based on an attribute value (axon delay value) that is specific to each synapse and a calculation function for controlling the intensity of a signal that passes through a synapse based on the state value of the synapse including the weight of the synapse.

FIG. 8 is a diagram showing the configuration of a synapse unit supporting a spiking neural network model in accordance with an embodiment of the present invention.

As shown in FIG. 8, the synapse unit includes an axon delay unit 800 for delaying a signal by a specific neural network update cycle based on an attribute value (axon delay value) that is specific to each synapse and a synapse potential unit 801 for controlling the intensity of a signal that passes through a synapse based on the state value of the synapse including the weight of the synapse.

In this case, assuming that a maximum time that may be delayed (the number of update cycles) is n, the axon delay unit 800 may include axon delay state value memory 808, a single n-bit shift register 802, a single n-to-1 selector 803, and axon delay attribute value memory 804 for storing the axon delay attribute value of a synapse, which are implemented as dual port memory in which the width of data including the axon delay state value of a synapse is (n−1) bit.

In this case, a 1-bit input from the input 707, 805 of the synapse unit and the data output of the read port of the axon delay state value memory 808 are connected to the shift register 802 as an input of a bit 0 and a bit 1 to a bit(n−1). Lower n bits of the output of the shift register 802 are connected to the data input 807 of the write port of the axon delay state value memory 808. The n-bit output of the shift register 802 is also connected to the input of the n-to-1 selector 803. One bit is selected based on the output value of the axon delay attribute value memory 804 and is outputted as the output of the n-to-1 selector 803.

In this case, when a value of 1 bit (a spike is generated) of the axon delay unit 800 is inputted, the value is stored in the 0-th bit of the shift register 802 and then stored in memory through the data input of the write port 807 of the axon delay state value memory 808. When a next neural network update cycle is started, the 1-bit signal appears as a 1 bit of the data output 806 of the read port of the axon delay state value memory 808. Whenever a neural network update cycle is repeated, the 1-bit signal is increased by 1 bit. As a result, the spike value of recent N neural network update cycles is stored as the n-bit output of the shift register 802, and a spike prior to a recent i-th spike appears in an i-th bit. Accordingly, if the axon delay attribute value memory 804 has a value i, a spike value prior to the i-th spike value is output to the output of the n-to-1 selector 803. If such a circuit of the axon delay unit 800 is used, there is an advantage in that all spikes can be delayed no matter how spikes are frequently generated.

Meanwhile, in general, regarding the calculation of the synapse potential unit 801 for controlling the signal of a synapse, various calculation equations are suggested even within a spiking neural network model. A design methodology capable of designing a specific synapse-specific function in a pipeline circuit form is described later.

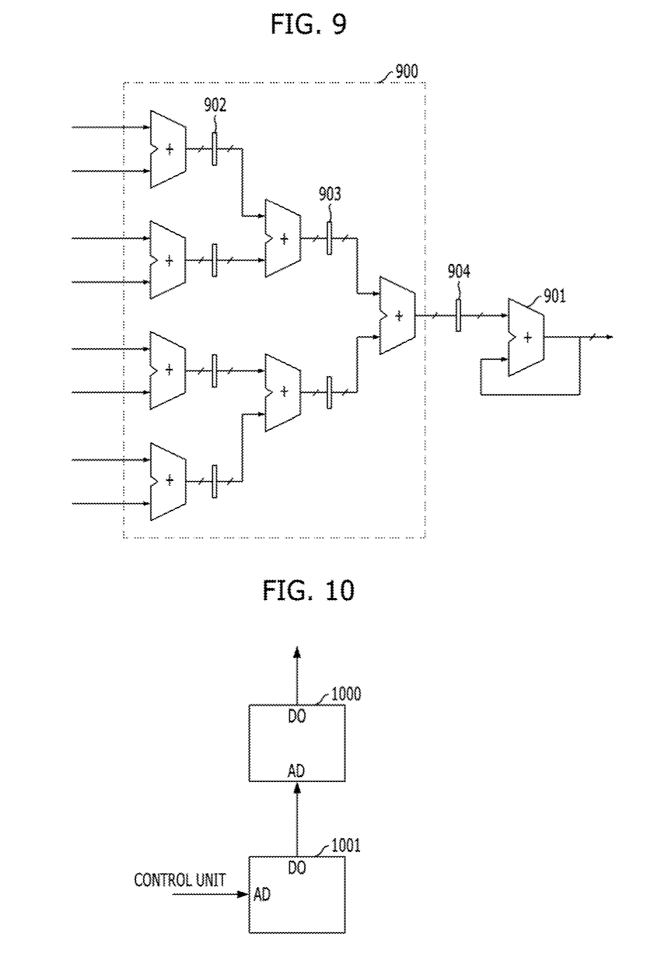

FIG. 9 is a diagram showing the configuration of a dendrite unit in accordance with an embodiment of the present invention.

As shown in FIG. 9, the structure of the dendrite unit 703 for most of neural network models may include an addition operation unit 900 having a tree structure for performing addition operation on a plurality of input values in one or more steps and an accumulator 901 for accumulating output values from the addition operation unit 900 and performing operation on the accumulated output value.

Registers 902 to 904 synchronized by a system clock are further included between respective adder layers and between the last adder and the accumulator 901. Accordingly, all the elements may operate as a pipeline circuit operating in synchronization with a system clock.

The soma unit 704 functions to calculate a new output value while updating a state value within the soma unit 704 using the net input value of a neuron, received from the dendrite unit 703, and the state value as factors, and to output the calculated new output value to an output 708. The structure of the soma unit 704 is not standardized because neuron-specific calculation may be greatly different depending on a neural network model.

The synapse-specific calculation of the synapse unit 702 or the neuron-specific calculation of the soma unit 704 are not standardized in various neural network models and may include a very complicated function. In this case, in an embodiment of the present invention, the synapse unit 702 or the soma unit 704 may be designed in the form of a high-speed pipeline circuit capable of processing each input/output every clock cycle using the following method for a specific calculation function.

(1) A step of defining a calculation function as one or a plurality of input values of the function, one or a plurality of output values, a specific number of state values, a specific number of attribute values, the initial value of a state value, and a calculation equation

(2) A step of representing the calculation equation in pseudo-assembly code. The input value defined at the step (1) becomes the input value of the pseudo assembly code, and the output value defined at the step (1) becomes a return value. On the premise that memory corresponding to each state value and attribute value is present, the attribute value and the state value are read from corresponding memory in the first part of the code, and a changed state value is stored in the memory in the last of the code.

(3) A step of listing shift register groups, each including a plurality of shift registers corresponding to the input value, state value, and attribute value, respectively, in an empty circuit by the number of commands of the assembly code designed at the step (2) and connecting the shift register groups. This is also called a register file.

(4) A step of adding a plurality of pieces of dual port memory, respectively corresponding to the state values and the attribute values defined at the step (1), to the circuit of the step (3) by disposing the plurality of pieces of dual port memory in parallel to the register file, connecting the data outputs of the read ports of the pieces of memory to the inputs of registers corresponding to the first register group of the register file, and connecting the outputs of registers corresponding to the state values of the last register group of the register file to the data inputs of the write ports of pieces of state value memory, respectively. In this case, an external input is connected to the input of a register corresponding to the first register group of the register file.

(5) A step of adding a calculator, corresponding to a corresponding operation function, between a register group corresponding to the position of a command for executing an operation function within the assembly code and a register group ahead of the register group corresponding to the position of the command within the register file. A temporary register may be further added between the calculators, if necessary. Connection between registers which becomes unnecessary due to the added calculator is removed.

(6) The circuit is optimized by removing unnecessary registers.

As an example of the design procedure, a case where the synapse-specific function is [Equation 5] below is described below.

$$a \cdot \frac{d x}{d t} = - x + b \cdot δ ( t - {t}_{j} ) \qquad [ Equation 5 ]$$

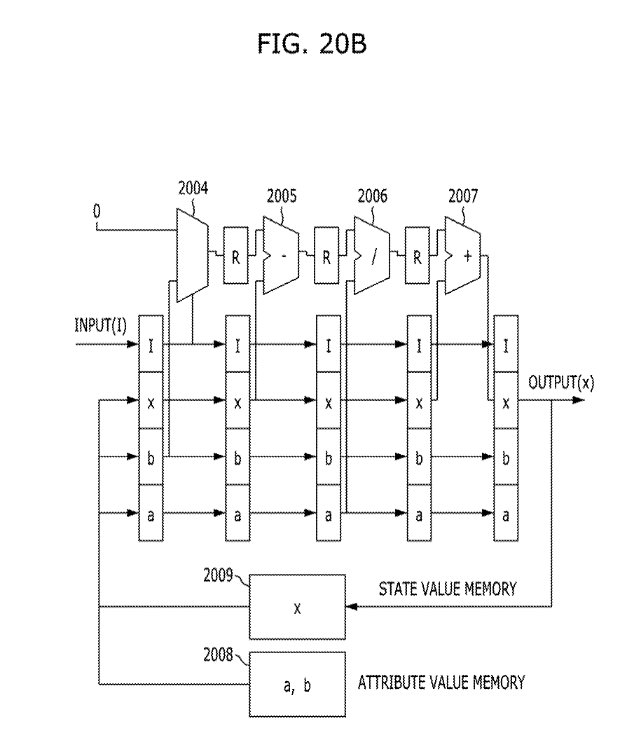

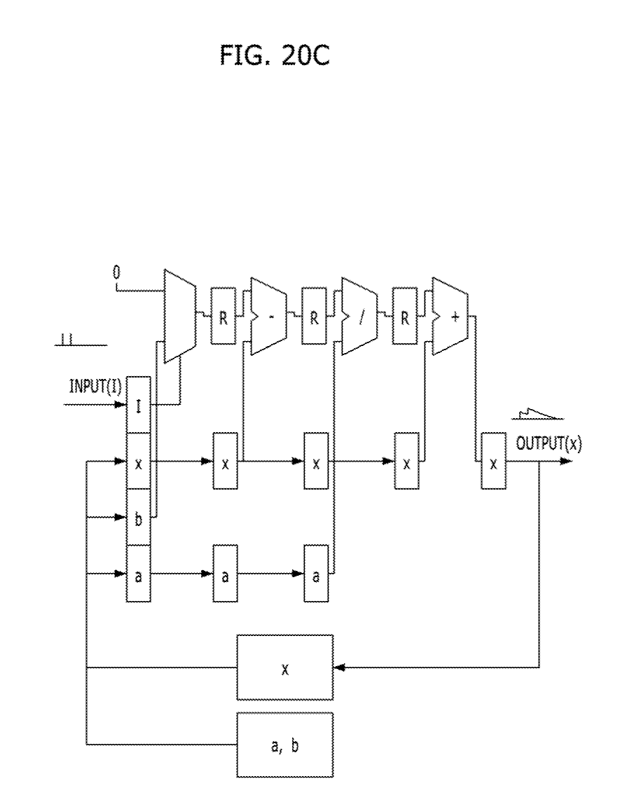

In the above function, a state value x is gradually reduced depending on the size of the state value x and a constant a over time. If a spike is inputted to the function as an input, the state value x is instantaneously increased by a constant b. In the synapse-specific function, an input value is a spike I of 1 bit, the state value is x, attribute values are a and b, and the initial value of the state value is x=0. If the function is represented in assembly code, it is represented as shown in FIG. 20a. The assembly code includes each conditional sentence 2000, subtraction 2001, division 2002, and addition 2003. The results in which the assembly code has been designed as in the design procedure are shown in FIG. 20b, and the results after optimization are shown in FIG. 20c. In the designed circuit, the conditional sentence 2000, the subtraction 2001, the division 2002, and the addition 2003 are implemented as a multiplexer 2004, a subtractor 2005, a divider 2006, and an adder 2007, respectively, and they include attribute value memory 2008 and state value memory 2009 for the attribute values a and b and the state value x. Furthermore, the shift registers operate as a pipeline circuit which operates in synchronization with a clock. Accordingly, all the steps are executed in parallel and have calculation speed (throughput) at which one input and output are processed for each clock cycle.

Accordingly, the circuit of the synapse unit 702, the soma unit 704, or the dendrite unit 703 (in a special case) may be implemented as a combination of the circuits designed as described above. Such a circuit is characterized in that it is implemented using state value memory a specific number of which is formed of dual port memory, a specific number of pieces of attribute value memory, and a pipeline circuit (calculation circuit) for sequentially calculating new state values and output values using data, sequentially read from the read ports of the state value memory and attribute value memory, as some or all of inputs and sequentially storing some or all of the results of the calculation in the state value memory.

A register 705, 706 operating in synchronization with a system clock may be further included between the units 702, 703, and 704 of the calculation sub-system 700 so that the units operate in a pipeline way.

Furthermore, a register operating in synchronization with a system clock may be further included between some or all of elements forming the inside of each of some or all of the units included in the calculation sub-system 700 so that the units may be implemented as a pipeline circuit operating in synchronization with a system clock.

Furthermore, the internal structure of each of some or all of the elements of the units included in the calculation sub-system 700 may be implemented as a pipeline circuit operating in synchronization with a system clock.

Accordingly, the entire calculation sub-system can be designed as a pipeline circuit operating in synchronization with a system clock.

The attribute value memory included in the calculation sub-system is memory characterized in that it only reads while calculation is in progress. In general, the range in which the attribute of a synapse or neuron is changed is not infinite, but may have one of a finite number of attribute values. Accordingly, the attribute value memory included in the calculation sub-system can reduce the total capacity of consumed memory using the method of FIG. 10. In this case, one piece of the attribute value memory may be implemented to include look-up memory 1000 which stores a plurality of (finite number) of attribute values, has its output connected to the calculation circuit, and provides the attribute values and attribute value reference number memory 1001 which stores a plurality of attribute value reference numbers and has its output connected to the address input of the look-up memory 1000. For example, if the number of all attributes of a synapse is 100 and the number of bits of an attribute value is 128 bits, when 1000 synapse attributes are stored, memory (128*1000) of 128 Kb is consumed if the method of FIG. 10 is not used, but memory (7*1000+100*128) of a total of 20 Kb is consumed if the method of FIG. 10 is used. Accordingly, the total capacity of memory can be greatly reduced.

As described above, in the case of a spiking model, such as an HH neural network model, a computational load is increased because many computations is required to calculate a neuron and update needs to be performed for each short cycle compared to the time taken for a biological neuron. In contrast, synapse-specific calculation does not require calculation in a short cycle, but is disadvantageous in that many computations for neuron-specific calculation needs to be performed if the update cycle of the entire system is matched up with neuron-specific calculation. A Multi-Time Scale (MTS) method for differently setting the calculation cycle of a synapse and the calculation cycle of a neuron may be used as a method for solving the disadvantage. In this method, synapse-specific calculation has a longer update cycle than neuron-specific calculation, and neuron-specific calculation is performed several times while synapse-specific calculation is performed once.

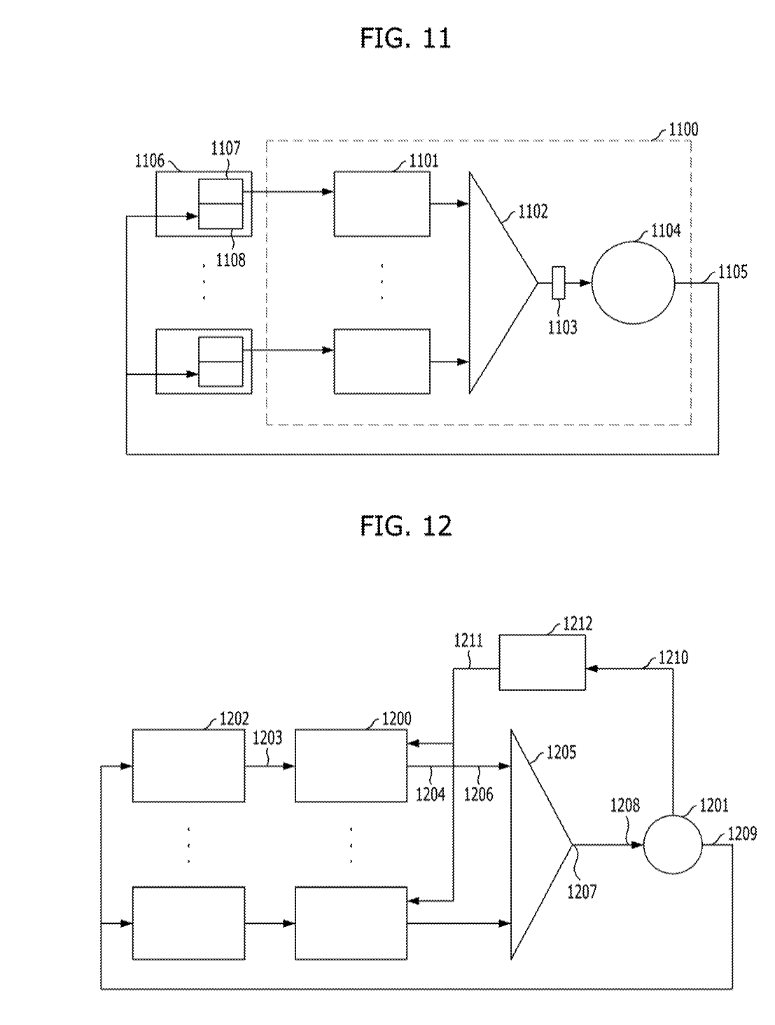

FIG. 11 is a diagram showing the structure of a system using the MTS method in accordance with an embodiment of the present invention.

As shown in FIG. 11, dual port memory 1103 for performing a buffering function between different neural network update cycles is additionally added between the dendrite unit 1102 and soma unit 1104 of the calculation sub-system 110. The memory Y of each of memory units 1106 may be implemented as dual replacement memory, such as that described above, using two pieces of independent memory 1107 and 1108. While one synapse-specific calculation cycle is performed and thus the net-input value of a neuron is stored in the dual port memory 1103, the soma unit 1104 reads the net-input value of the corresponding neuron from the dual port memory 1103 several times and repeatedly performs neuron-specific calculation. That is, the calculation sub-system 110 differently sets a neural network update cycle in which synapse-specific calculation is performed in the synapse unit 1101 and the dendrite unit 1102 and a neural network update cycle in which neuron-specific calculation is performed in the soma unit 1104 and repeatedly performs the neural network update cycle in which the neuron-specific calculation is performed more than once while the neural network update cycle in which the synapse-specific calculation is performed is performed once. Accordingly, there is an advantage in that the same once-calculated net-input value continues to be used while neuron-specific calculation is performed several times. Furthermore, the output of the soma unit 1104, that is, the spike of a neuron, is accumulatively stored in one piece of the memory 1108 of the pieces of memory Y while synapse-specific calculation continues. When the calculation cycle of the synapse-specific calculation is terminated, the roles of the two pieces of memory 1107 and 1108 of the memory Y are changed by the multiplexer circuit, and thus synapse-specific calculation may continue to be performed based on an accumulated spike.

If such a multi-time scale method is used, there are advantages in that the number of synapse units can be reduced and high performance can be obtained using the same hardware resource because the soma unit can be used more efficiently.

FIG. 12 is a diagram showing a structure for calculating a neural network using a learning method, such as that described in [Equation 3], in accordance with an embodiment of the present invention.

As shown in FIG. 12, each of synapse units 1200 includes synapse weight memory for storing the weight value of a synapse as one of pieces of state value memory and further includes the other input 1211 for receiving a learning state value. A soma unit 1201 further includes the other output 1210 for outputting a learning state value. The other output 1210 of the soma unit 1201 is connected to the other inputs 1211 of all the synapse units 1200 in common.

The neural network computing device may distribute and store the reference numbers of neurons, connected to the input synapses of all neurons within a neural network, in the memory M 112 of the plurality of memory units 102, 1202, may store the stored reference numbers in the synapse weight memory of the plurality of synapse units 1200 as the initial values of the synapse weights of the input synapses of all the neurons, and may perform a learning calculation function in accordance with the following step a to step f.

a. The step of sequentially outputting, by the plurality of memory units 1202, the values of neurons connected to the input synapses of all neurons

b. The step of sequentially calculating, by the synapse units 1200, the output values of new synapses using the output values of input neurons sequentially transferred by the memory units 1202 through one inputs 1203 and synapse weight values sequentially transferred from the outputs of the synapse weight memory as inputs and outputting the output values of the new synapses to the outputs 1204 of the synapse units

c. The step of sequentially receiving, by a dendrite unit 1205, the outputs 1204 of the plurality of synapse units through inputs 1206 including a plurality of inputs, sequentially calculating the sum of the inputs transferred by all the synapses of the neurons, and outputting the calculated sum through an output 1207

d. The step of sequentially receiving, by the soma unit 1201, the input values of the neurons from the output 1207 of the dendrite unit through an input 1208, updating the state values of the neurons, sequentially calculating new output values, sequentially outputting the new output values through one output 1209, sequentially calculating new learning state values Lⱼ based on the input values and state values at the same time, and sequentially outputting the new learning state values through the other outputs 1210

e. The step of sequentially calculating, by the plurality of synapse units 1200, new synapse weight values using the learning state values Lⱼ sequentially transferred through the other input 1211, the output values of the input neurons sequentially transferred through one inputs 1203, and the synapse weight values sequentially transferred from the outputs of the synapse weight memory as inputs and storing the new synapse weight values in the synapse weight memory

f. The step of sequentially storing a value, output to one output 1209 of the soma unit 1201, through the write ports of the memory Y of the plurality of memory units 1202

In this case, in the learning calculation method, a time lag is generated between the output value and synapse weight value of an input neuron and the other output 1210 of the soma unit 1201. In order to solve the time lag, learning state value memory 1212 which functions to temporarily store a learning state value and to control timing and which is implemented using dual port memory may be further included between inputs to which the other inputs 1211 of the plurality of synapse units 1200 are connected in common. In this case, learning calculation is performed at a point of time at which the output value of an input neuron sequentially transferred through one input 1203 of the synapse unit 1200 and a synapse weight value sequentially transferred from the output of the synapse weight memory are generated. The learning state value Lⱼ sequentially transferred through the other input 1211 is calculated by the soma unit 1201 in a previous neural network update cycle and is used as a value stored in the learning state value memory 1212.

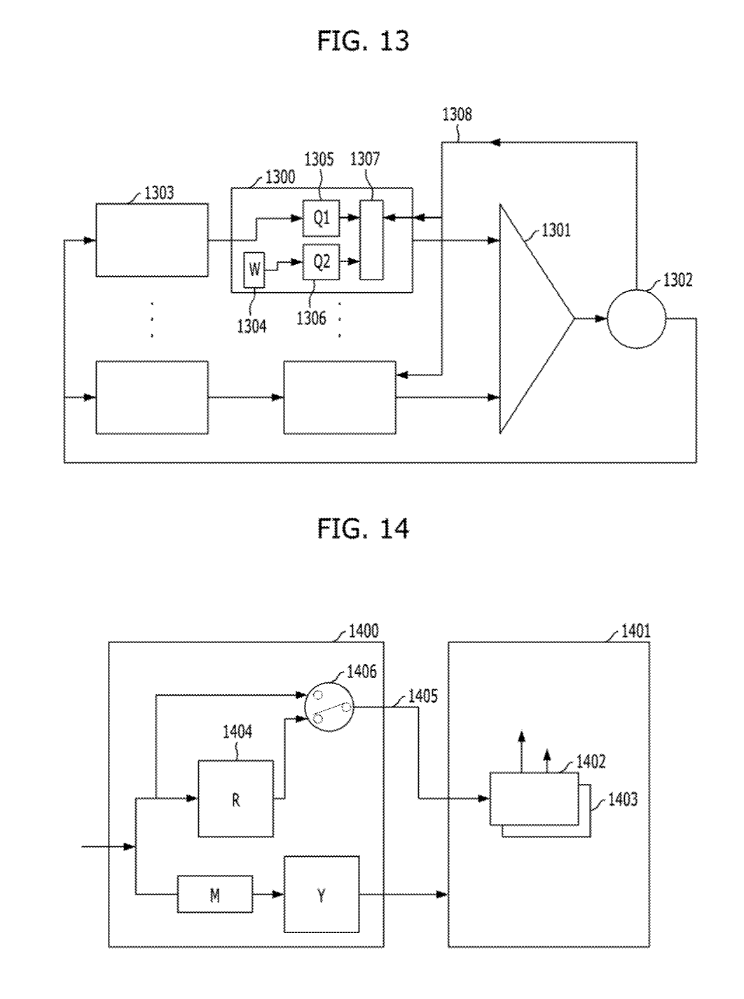

As an alternative, as shown in FIG. 13, a learning calculation function may be performed in accordance with the following step a to step f.

a. The step of sequentially outputting, by a plurality of memory units 1303, the values of neurons connected to the input synapses of all the neurons

b. The step of sequentially calculating, by synapse units 1300, new synapse output values, respectively, using the output values of input neurons sequentially transferred by the memory units 1303 and synapse weight values sequentially transferred from the outputs of synapse weight memory 1304 as inputs, outputting the new synapse output values to the outputs of the synapse units 1300, and simultaneously inputting the output values and synapse weight values of the input neurons sequentially transferred from the outputs of the synapse weight memory 1304 to two first-input first output queues 1305 and 1306

c. The step of sequentially receiving, by a dendrite unit 1301, inputs including a plurality of inputs from the outputs of the plurality of synapse units 1300, sequentially calculating the sum of the inputs transferred by all the synapses of the neurons, and outputting the calculated sum through an output

d. The step of sequentially receiving, by a soma unit 1302, the input values of the neurons from the output of the dendrite unit 1301, updating the state values of the neurons, sequentially calculating new output values, sequentially outputting the output values through one output, simultaneously calculating new learning state values Lⱼ based the input values and the state values sequentially, and sequentially outputting the calculated new learning state values to the other output 1308

e. The step of sequentially calculating (1307), by each of the plurality of synapse units 1300, a new synapse weight value using the learning state value Lⱼ sequentially transferred through the other input 1308, the output value of an input neuron delayed by the two queues 1305 and 1306 from the outputs of the queues, and a synapse weight value as inputs and storing the new synapse weight value in the synapse weight memory 1304

f. The step of sequentially storing a value, output to one output of the soma unit 1302, through the write ports of the memory Y of the plurality of memory units 1202

If this method is used, all data used in learning can be calculated using data generated in a current update cycle.

A process for storing, by the neural network computing device, data in the memory M 112 of the plurality of memory units 102 and the state value memory and attribute value memory of the plurality of synapse units, as a method for calculating a neural network including a bidirectional connection in which forward calculation and backward calculation are simultaneously applied to the same synapse as in the back-propagation algorithm, may be executed in accordance with the following process a to process d.

a. The process of configuring a spread network by adding a new backward synapse, connected from a neuron A to a neuron B, to a forward network, assuming that a neuron providing a forward input to each of all bidirectional connections is A and a neuron receiving the forward input is B

b. The process of disposing the forward synapse and backward synapse of each bidirectional connection in the same memory unit and synapse unit using a synapse disposition algorithm, which is a method for distributing and storing information about the input synapses of all neurons within the spread network in the plurality of memory units and the plurality of synapse units

c. The process of storing the synapse state value and synapse attribute value of a corresponding synapse in the k-th addresses of specific state value memory and attribute value memory, respectively, which are included in each of the plurality of synapse units if the corresponding synapse is a forward synapse

d. The process of, when accessing the state values and attribute values of synapses stored in the state value memory and attribute value memory of the plurality of synapse units, accessing k-th addresses stored in the state value memory and the attribute value memory if the k-th synapse is a forward synapse, accessing the state value and attribute value of a forward synapse corresponding to a backward synapse if the k-th synapse is a backward synapse, and sharing, by the forward synapse and the backward synapse, the same state value and attribute value

FIG. 14 is an exemplary diagram of a memory unit in accordance with an embodiment of the present invention.

A method for accessing the state value and attribute value of a forward synapse corresponding to a backward synapse is described below if a corresponding synapse is the backward synapse, when each of the plurality of memory units 102, 1400 accesses the state value memory 1402 and attribute value memory 1403 of a synapse unit 1401. As shown in FIG. 14, each of the plurality of memory units 1400 may further include backward synapse reference number memory 1404 which stores the reference number of a forward synapse corresponding to a backward synapse and a digital switch 1406 which is controlled by the control unit 100 and which is used to select one of the control signal of the control unit 100 and the data output of the backward synapse reference number memory 1404, to connect the selected signal or output to the synapse unit 1401 through the output 1405 of the memory unit 1400, and to sequentially select the state value and attribute value of a synapse. In this case, if a synapse is a forward synapse, the control unit directly provides the control signal without the intervention of the backward synapse reference number memory.

In the above process b, a method for representing all the bidirectional connections of a neural network as edges, representing all neurons within the neural network as nodes in a graph, representing the number of a memory unit in which synapses are stored in the neural network as color in the graph, and disposing forward and backward synapses in the number of the same memory unit using an edge coloring algorithm in the graph may be used in the synapse disposition algorithm for disposing synapses so that the positions of a memory unit in which the data of a forward synapse is stored and a memory unit in which the data of a backward synapse is stored are the same with respect to each of bidirectional connections included in a neural network. In this case, the edge coloring algorithm for assigning the same color to both sides of an edge and not assigning the same color to other edges of a neuron on both sides, which is connected to the corresponding edge, intrinsically has the same problem as that in which the same memory unit number is assigned to the forward synapse and backward synapse of a specific synapse. Accordingly, the edge coloring algorithm may be used as the synapse disposition algorithm.

For the same purpose as that described above, if all bidirectional connections are included in a complete bipartite graph between two layers, that is, if a synapse shared by forward and backward synapses connects two neuron groups and all the neurons of one group are respectively connected to all the neurons of the other group, when each of the bidirectional connections is connected from the i-th neuron of one group to the j-th neuron of the other group, the structure of a neural network, that is, the subject of calculation, may not use the edge coloring algorithm, but may use a simpler method for disposing the corresponding forward synapse and backward synapse in (i+j) mod p-th memory unit numbers, respectively. The same memory unit number is assigned to “(i+j) mod p” because the forward and backward synapses have the same value.

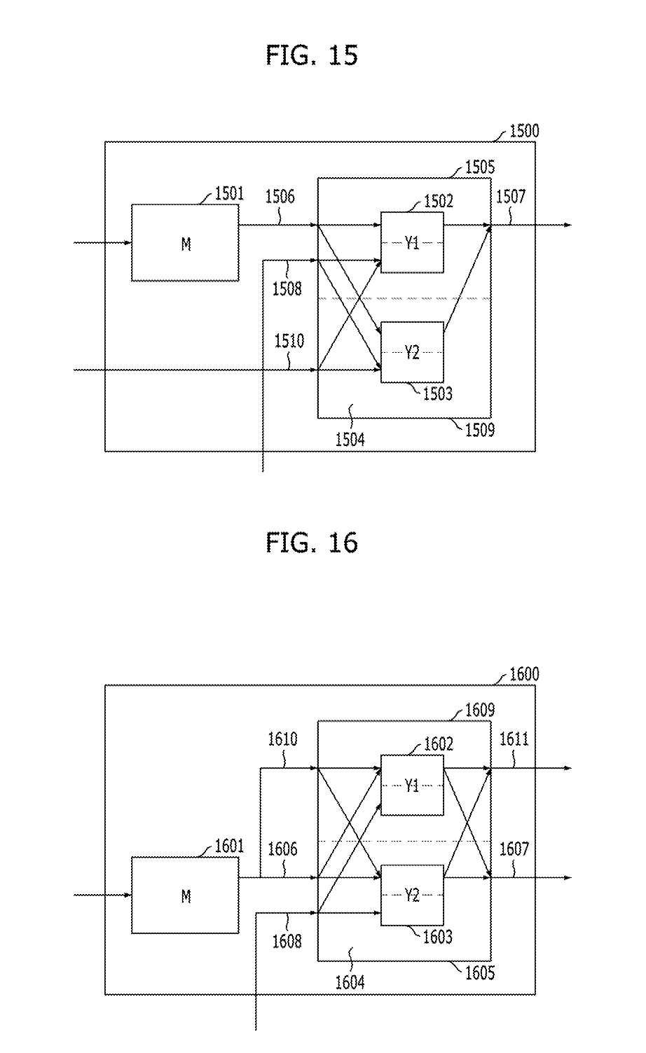

FIG. 15 is another exemplary diagram of a memory unit in accordance with an embodiment of the present invention.

As shown in FIG. 15, each of a plurality of memory units 102, 1500 may include memory M 1501 for storing the reference number of a neuron connected to a synapse, memory Y1 1502 formed of dual port memory having two ports of a read port and write port, memory Y2 1503 formed of dual port memory having two ports of a read port and write port, and a dual memory swap circuit 1504 controlled in response to a control signal from the control unit 100 and formed of a plurality of digital switches for changing and connecting all the inputs and outputs of the memory Y1 1502 and the memory Y2 1503.

A first logical dual port 1505 formed by the dual memory swap circuit 1504 has the address input 1506 of the read port of the first logical dual port 1505 connected to the output of the memory M 1501, has the data output 1507 of the read port of the first logical dual port 1505 become the output of the memory unit 1500, and has the data input 1508 of the write port of the first logical dual port 1505 connected to the data inputs of the write ports of the first logical dual ports of other memory units in common. The first logical dual port 1505 is used to store a newly calculated neuron output. A second logical dual port 1509 formed by the dual memory swap circuit 1504 has the data input 1510 of the write port of the second logical dual port 1509 connected to the data inputs of the write ports of the second logical dual ports of other memory units in common. The second logical dual port 1509 is used to store the value of an input neuron to be used in a next neural network update cycle.

If such a structure is used, there is an advantage in that calculation and the storage of input data can be performed in parallel during the entire neural network update cycle. This method may be effectively used if the number of input neurons is many, which may be said to be a common characteristic of a multi-layer neural network.

FIG. 16 is yet another exemplary diagram of a memory unit in accordance with an embodiment of the present invention.

As shown in FIG. 16, each of a plurality of memory units 102, 1600 includes memory M 1601 for storing the reference number of a neuron connected to a synapse, memory Y1 1602 formed of dual port memory having two ports of a read port and a write port, memory Y2 1603 formed of dual port memory having two ports of a read port and a write port, and a dual memory swap circuit 1604 controlled in response to a control signal from the control unit 100 and formed of a plurality of digital switches which exchanges and connects all the inputs and outputs of the memory Y1 1602 and the memory Y2 1603. A first logical dual port 1605 formed by the dual memory swap circuit 1604 has the address input 1606 of the read port connected to the output of the memory M 1601, has the data output 1607 of the read port become one output of the memory unit 1600, and has the data input 1608 of the write port connected to the data inputs of the write ports of the first logical dual ports of other memory units in common. The first logical dual port 1605 is used to store a newly calculated neuron output. A second logical dual port 1609 formed by the dual memory swap circuit may have the address input 1610 of the read port connected to the output of the memory M 1601, may have the data output 1611 of the read port connected to the other output of the memory unit 1600, and may output the output value of a neuron in a previous neural network update cycle.

Accordingly, this structure can output the output value of a neuron in a previous neural network cycle and the output value of a neuron in a current neural network cycle at the same time, and it may be effectively used if a neural network calculation model requires a neuron output in a neural network update cycle T and a neuron output in a neural network update cycle T−1 at the same time.

The method of FIG. 15 and the method of FIG. 16 may be used together (not shown). In this case, each of the plurality of memory units may include the memory M for storing the reference number of a neuron connected to a synapse, the memory Y1 formed of dual port memory having the two ports of the read port and write port, the memory Y2 formed of dual port memory having the two ports of the read port and write port, memory Y3 formed of dual port memory having two ports of a read port and write port, and a triple memory swap circuit controlled in response to a control signal from the control unit and formed of a plurality of digital switches for sequentially changing and connecting all the inputs and outputs of the memory Y1 to the memory Y3.

A first logical dual port formed by the triple memory swap circuit has the data input of the write port connected to the data inputs of the write ports of the first logical dual ports of other memory units in common, and it is used to store the value of an input neuron to be used in a next neural network update cycle. A second logical dual port formed by the triple memory swap circuit has the address input of the read port connected to the output of the memory M, has the data output of the read port become one output of the memory unit, and has the data input of the write port connected to the data inputs of the write ports of the second logical dual ports of other memory units in common. The second logical dual port is used to store the newly calculated output of a neuron. A third logical dual port formed by the triple memory swap circuit has the address input of the read port connected to the output of the memory M, has the data output of the read port connected to the other output of the memory unit, and outputs the output value of a neuron in a previous neural network update cycle.

This method is a mixture of the aforementioned methods of FIGS. 15 and 16 and may be used if the input of input data, the execution of calculation, and a learning process based on the value of a previous neuron are generated at the same time.

In an embodiment of the present invention, in a method for calculating the back-propagation neural network algorithm, the synapse unit includes synapse weight memory for storing the weight value of a synapse as one of pieces of state value memory and further includes the other input for receiving a learning state value. The soma unit further includes learning temporary value memory for temporarily storing a learning temporary value, the other input for receiving learning data, and the other output for outputting the learning state value. The calculation sub-system functions to temporarily store the learning state value and to control timing and further includes learning state value memory having an input unit connected to the other output of the soma unit and an output unit connected to the other input of the synapse unit in common.

As a method for calculating a back-propagation neural network learning algorithm, the neural network computing device may distribute and store the reference numbers of neurons, connected to the input synapses of neurons included in a corresponding layer, in specific address ranges of the first memory of the plurality of memory units, may store the initial values of the synapse weights of the input synapses of all the neurons in the synapse weight memory of the plurality of synapse units, and may perform a calculation function in accordance with the following step a to step e, with respect to each of one or a plurality of hidden layers and an output layer in a forward network and each of one or a plurality of hidden layers in a backward network.

a. The step of storing input data in the memory Y of the plurality of memory units as the value of a neuron of an input layer

b. The step of sequentially performing multi-layer forward calculation from a layer, connected to the input layer, to the output layer

c. The step of calculating a difference between learning data received through the other input of the soma unit and the newly calculated output value of each of neurons of the output layer, that is, an error value

d. The step of sequentially performing the propagation of the error value from a layer, connected to the output layer, to the layer, connected to the input layer, with respect to each of the layers of the backward network of the one or the plurality of hidden layers

e. The step of adjusting the weight value of a synapse connected to each neuron from the layer connected to the input layer to the output layer with respect to each of the one or the plurality of hidden layers and one output layer

In this case, as described above with reference to FIG. 15, the second memory of the plurality of memory units may include the two pieces of dual port memory and two pieces of logical dual port memory according to the dual memory swap circuit, input data to be used in a next neural network update cycle may be previously stored in the second logical dual port memory, and the aforementioned step a and steps b-e may be performed in parallel.

The soma unit 704 of the calculation sub-system 106 calculates a learning temporary value and stores the calculated learning temporary value in the learning temporary value memory for temporary storage until a point of time at which a learning state value Lⱼ is calculated in the future, when performing the step b.

The soma unit 704 of the calculation sub-system 106 may perform the step of calculating the error value of the output neuron at the step c along with the step b of forward propagation, thereby being capable of reducing a calculation time.

The soma unit 704 of the calculation sub-system 106 may calculate the error value of the neuron in each of the steps c and d, may calculate a learning state value Lⱼ, may output the calculated learning state value Lⱼ through the other output, may store the calculated learning state value Lⱼ in the learning state value memory, and may use the learning state value Lⱼ, stored in the learning state value memory, to calculate the weight value of the synapse Wᵢⱼ at the step e.

The memory Y of the plurality of memory units 102 includes the two pieces of dual port memory and two pieces of logical dual port memory according to the dual memory swap circuit, as described above with reference to FIG. 16. The second logical dual port memory may output the output value of a neuron in a previous neural network update cycle to the other output of the memory unit and perform the step e and the step b in a next neural network update cycle at the same time, thereby being capable of reducing a calculation time.

In an embodiment of the present invention, in the method for performing the learning calculation of a deep relief network, with respect to each of the RBM-first, second, and third steps, the reference numbers of neurons connected to the input synapse of the neurons included in a corresponding step are distributed, accumulated, and stored in specific address ranges of the first memory of the plurality of memory units, backward synapse information in the RBM-second step is stored in the backward synapse reference number memory, and the initial values of the synapse weights of the input synapses of all the neurons are accumulated and stored in the synapse weight memory of the plurality of synapse units. The region of the second memory may be divided into three equal parts and called regions Y(1), Y(2), and Y(3), respectively. In a calculation procedure for learning one learning datum, a calculation function may be performed in accordance with the following step a to step c.

a. The step of storing learning data in the region Y(1). The learning data becomes vpos in the aforementioned description of the deep relief network.

b. The step of setting variables S=1 and D=2

c. The step of performing the following process c1 to process c6 on each of RBMs within a neural network

c1. The process of performing, by the calculation sub-system, the calculation of the RBM-first step using the region Y(S) of the second memory of the memory unit as an input and storing the vector hpos of the calculation in the region Y(D) of the secondary memory

c2. The process of performing, by the calculation sub-system, the calculation of the RBM-second step using the region Y(D) of the second memory of the memory unit as an input and storing the results of the calculation in the region Y(3)

c3. The process of performing, by the calculation sub-system, the calculation of the RBM-second step using the region Y(3) of the second memory of the memory unit as an input. In this case, the results of the calculation are not stored in the secondary memory of the memory unit.

c4. The process of adjusting the values of all synapses

c5. The process of exchanging the values of the variables S and D

c6. The process of storing next learning data in the region Y(1) if a current RBM is the last RBM

The process c3 to process c6 may be performed in a single process at the same time.

If such a method is used, the vector hpos in a single RBM becomes the input value of a visible layer in a next RBM. Accordingly, there is an advantage in that the capacity of memory used can be reduced because calculation can be performed regardless of the number of RBMs using the three regions of the memory Y.

In a complicated calculation procedure as in the deep relief network, the data of several steps is accumulated in the memory of each of the memory units or the state value memory of the synapse unit and is stored while forming a layer. Accordingly, there is a problem in that control by hardware becomes extremely difficult because only a single region of the layer is used in each calculation step. As a method for solving the problems, there is a method for adding a circuit for calculating an offset to the address input of the memory so that the access range of the memory is different depending on the setting the offset. The control unit may change the region of memory by changing the offset value of each of pieces of the memory whenever each step is started. That is, the neural network computing device further includes an offset circuit for enabling the control unit to easily change the access range of the memory to the address input stage of each of the memory unit or one or a plurality of pieces of memory within the calculation sub-system by designating a value obtained by adding a designated offset value to an accessed address value as the address of the memory.

As a calculation procedure of a neural network model becomes complicates like a deep relief network, when control of a system is accompanied by a complicated calculation procedure having several steps, the control unit may include a Stage Operation Table (SOT) including information required to generate a control signal for each control step in order to facilitate control, may read the records of the SOT one by one for each control step, and may use the read records in a system operation. The SOT includes a plurality of the records, and each record includes various system parameters required to perform a single calculation procedure, such as the offset of each piece of memory and the size of a network. Some of the records may be included in the identifiers of other records and function as a GO TO sentence. When each step is started, a system reads system parameters from a current record of the SOT, set the system, and sequentially moves a current record pointer to a next record. If the current record is a GO TO sentence, the system moves the current record pointer to a record identifier included in a record not to a sequential record.

A neural network computing system for combining a plurality of the neural network computing devices and performing calculation of higher performance is described below.

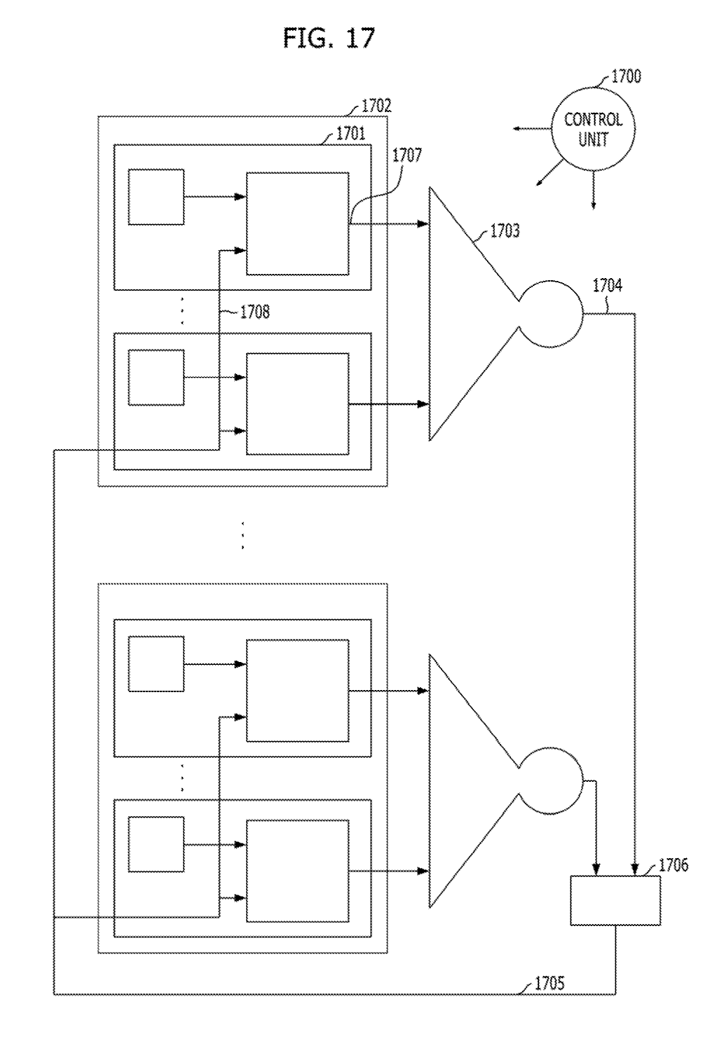

FIG. 17 is an exemplary diagram of a neural network computing system in accordance with an embodiment of the present invention.

As shown in FIG. 17, the neural network computing system includes a control unit 1700 for controlling the neural network computing system, a plurality of network sub-systems 1702 each including a plurality of memory units 1701, a plurality of calculation sub-systems 1703 each for calculating the new output values of post-synaptic neuron using the output values of pre-synaptic neurons received from a plurality of the memory units 1701 included in one of the plurality of network sub-systems 1702 and outputting the calculated new output value, and a multiplexer 1706 for multiplexing the output 1704 of the plurality of calculation sub-systems between the output 1704 of the plurality of calculation sub-systems 1703 and an input signal 1705 to which the feedback inputs of all the memory units 1701 are connected in common.

Each of the plurality of memory units 1701 of the network sub-system 1702 has the same structure as the memory unit 102 of the aforementioned single system and includes the output 1707 for outputting the output value of a pre-synaptic neuron and an input 1708 for receiving the output value of a new post-synaptic neuron.

If the number of synapse bundles per neuron is n, frequency that data output from the output 1704 of each of the plurality of calculation sub-system 1703 is generated is one per n clock cycles. Accordingly, when the multiplexer 1706 multiplexes the outputs of the calculation sub-systems 1703, it can multiplex a maximum number of n calculation sub-systems 1703 without overflow. Multiplexed data may be stored in the memory Y of all the memory units 1701 within all the network sub-systems 1702.

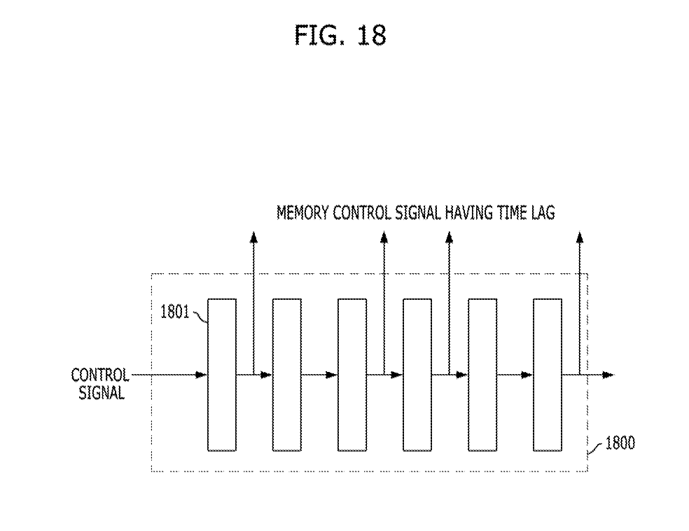

As shown in the implementation method, in the systems described in an embodiment of the present invention, a large number of control signals are used to control the address of memory. The address signals of pieces of the memory of each memory unit basically have the same order and have a time lag in order to sequentially access a plurality of synapse bundles, but have a sequence of the same signals. In order to use this, as shown in FIG. 18, the control unit 100 includes a plurality of shift registers 1800 connected in a row. If only the signal of a first register 1801 is sequentially changed, other memory control signals having a time lag are sequentially generated, thereby being capable of simplifying the configuration of the control circuit.

The memory structure in which a plurality of the neural network computing devices is combined in accordance with an embodiment of the present invention may also be used in a multi-processor computing system including a plurality of common processors as well as all neural network computing systems.

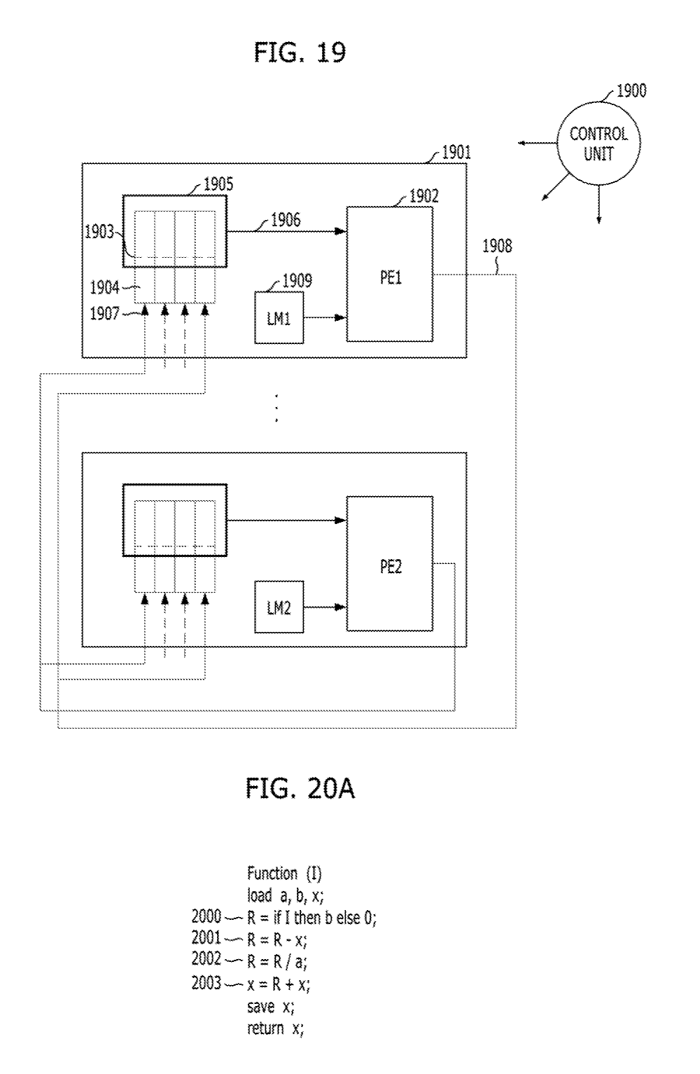

FIG. 19 is a diagram showing the configuration of a multi-processor computing system in accordance with another embodiment of the present invention.

As shown in FIG. 19, the multi-processor computing system includes a control unit 1900 for controlling the multi-processor computing system and a plurality of processor sub-systems 1901 each for calculating some of the computational load and outputting some of the results of the calculation in order to share some of the results with other processors.

In this case, each of the processor sub-systems includes a single processing element 1902 for calculating some of the computational load and outputting some of the results of the calculation in order to share some of the results with other processors and a single memory group 1903 for performing a communication function between the single processing element 1902 and other processors. The memory group 1903 includes N pieces of dual port memory 1904 each having a read port and a write port and a decoder circuit (not shown) for integrating the read ports of the N pieces of dual port memory 1904 so that the N pieces of dual port memory 1904 performs the function of integrated memory 1905 of an N times capacity in which each of the pieces of memory occupies some of a total capacity. In the integrated memory 1905 integrated by the decoder circuit of the memory group, the bundle 1906 of an address input and a data output is connected to the processing element 1902 and always accessed by the processing element 1902. The write ports 1907 of the N pieces of dual port memory are connected to the outputs 1908 of the N processor sub-systems 1901, respectively.

When the processing elements 1902 within all the processor sub-systems 1901 obtain data that needs to be shared with other processing elements, they output the data as the outputs 1908. The output data is stored in the dual port memory 1904 of the memory group 1903 of each of all the processor sub-systems 1901 through the one write port 1907. All other processor sub-systems can access the stored data through the read ports of the memory groups as soon as the output data is stored.

In general, when communication is generated between processors in a multi-processor computing system, delay is generated due to the time taken to send data or the time taken to wait for data, resulting in delay of calculation speed. Accordingly, it is difficult to obtain calculation speed corresponding to the number of combined devices. If the method of FIG. 19 is used, however, communication is performed by only accessing memory without moving data from one device to the other device. Accordingly, there is an advantage in that an increase of linear speed can be expected as the number of combined devices is increased.

Furthermore, if the processor sub-system 1901 further includes local memory 1909 independently used by the processing element, if the space of memory that is accessible through the read port 1906 of the memory group and the read space of the local memory 1909 are integrated into a single memory space, the processing elements 1902 can directly access the contents of the local memory 1909 and the contents of shared memory (memory group), stored by other systems, through a program without distinction. That is, the local memory 1909 and the integrated memory integrated by the decoder circuit of the memory group are mapped to a single memory map, and the program of the processing element 1902 accesses the data of the local memory and the data of the integrated memory without distinction. Accordingly, there is an additional advantage in that a matrix operation or image processing can be easily performed.

For example, a case where a plurality of processor sub-systems performs processing on an image processing system for processing an image represented as a combination of a plurality of pixels of a two-dimensional screen is taken into consideration. Each of the processor sub-systems calculates part of the two-dimensional screen. In general, an image processing algorithm applies a series of filter functions to the original image, and thus the value of each of the pixels of an n-th filter-processed screen experiences a procedure that is used to calculate an (n+1)-th filter-processed screen. The calculation of a specific pixel is performed using the inputs of pixels neighboring the position of the corresponding pixel in a previous filter-processed screen. Accordingly, the processor sub-system needs to refer to pixel values calculated by other processor sub-systems in order to calculate the edge pixels of a screen region that is responsible for processing. In this case, if the results calculated by each of the processor sub-systems are shared with other processor sub-systems using the aforementioned method, each of the processor sub-systems can perform calculation without a hardware device for separate communication and without a delay time taken for communication.

Such a multi-processor computing system needs to secure a memory space for storing data transmitted by all other processor sub-systems and input (write) interfaces for all other processor sub-systems in all the processor sub-system. If the processor sub-systems are increased massively, the capacity of memory and the number of pins of the input interfaces may be excessively increased. As a method for solving the problem, a method for implementing some of a plurality of pieces of the dual port memory, included in each of the memory groups, using virtual memory to which physical memory has not been allocated may be used. For example, when the large-scale processor sub-system 1902 forms a two-dimensional matrix and is connected, each of all the processor sub-systems 1902 includes only dual port memory that belongs to the pieces of dual port memory of the memory group and that corresponds to a surrounding processor sub-system, and physical memory and input ports are not connected in pieces of the remaining dual port memory. As described above, a method for maintaining the memory spaces of all the processor sub-system internally, but not allocating physical memory other than an adjacent memory space that requires communication is used. Accordingly, a memory capacity and the number of input pins that are required can be minimized.

In accordance with an embodiment of the present invention, there are advantages in that there is no restriction to the network topology of a neural network, the number of neurons, and the number of synapses and various neural network models including a specific synapse function and neuron function can be executed.

Furthermore, in accordance with an embodiment of the present invention, there are advantages in that the number p of synapses capable of being processed by a neural network computing system at the same time can be determined randomly and designed and high-speed execution is possible because a maximum of p synapses can be recalled or trained at the same time every clock cycle.

Furthermore, in accordance with an embodiment of the present invention, there is an advantage in that the precision of an operation can be increased randomly without reducing the highest speed which may be implemented.

Furthermore, in accordance with an embodiment of the present invention, there is an advantage in that a high-speed multi-system can be constructed by combining a specific plurality of systems without reducing the mean speed per system.

Furthermore, if an embodiment of the present invention is applied, there are advantages in that a high-capacity general-purpose neural network computer can be implemented and applied to various artificial neural network application fields because it can also be integrated into a small-sized semiconductor.

The present invention may be used in a digital neural network computing technology field, etc.

As described above, although the present invention has been described in connection with the restricted embodiments and drawings, the present invention is not limited to the embodiments. A person having ordinary skill in the art to which the present invention pertains may substitute, modify, and change the present invention without departing from the technical spirit of the present invention from the description from the writing. Accordingly, the scope of the present invention should not be limited to the aforementioned embodiments, but should be defined by the claims and equivalent thereof.

1. A neural network computing device, comprising:
a control unit for controlling the neural network computing device;
a plurality of memory units each for outputting an output value of a pre-synaptic neuron using dual port memory; and
a single calculation sub-system for calculating an output value of a new post-synaptic neuron using the output values of the pre-synaptic neurons received from the plurality of memory units and feeding the new output value back to each of the plurality of memory units,
wherein each of the plurality of memory units comprises
first memory for storing a reference number of the pre-synaptic neuron; and
second memory which comprises the dual port memory having a read port and a write port and which stores an output value of a neuron.

2. (canceled)

3. The neural network computing device of claim 1, wherein the neural network computing device distributes and stores reference numbers of neurons connected to input synapses of all neurons within a neural network to the first memory of the plurality of memory units and performs a calculation function in accordance with step a to step d below.
a. The step of sequentially changing values of address inputs of the first memory of the plurality of memory units and sequentially outputting reference numbers of neurons connected to input synapses of the neurons to data outputs of the first memory
b. The step of sequentially outputting output values of the neurons connected to the input synapses of the neurons to data outputs of the read ports of the second memory of the plurality of memory units so that the output values are inputted to a plurality of inputs of the calculation sub-system through outputs of the plurality of memory units
c. The step of sequentially calculating, by the calculation sub-system, output values of new post-synaptic neurons
d. The step of sequentially storing the output values of the post-synaptic neurons calculated by the calculation sub-system through the write ports of the second memory of the plurality of memory units

4. (canceled)

5. The neural network computing device of claim 1, wherein the neural network computing device distributes, accumulates, and stores reference numbers of neurons connected to input synapses of neurons, included in a corresponding layer, in a specific address range of the first memory of the plurality of memory units with respect to each of one or a plurality of hidden layers and an output layer and calculates a neural network comprising a multi-layer network in accordance with step a and step b below.
a. The step of storing input data in the second memory of the plurality of memory units as a value of a neuron of an input layer
b. The step of sequentially calculating each of the hidden layers and the output layer from a layer connected to an input layer to the output layer in accordance with a process b1 to a process b4 below
b1. The process of sequentially changing values of address inputs of the first memory of the plurality of memory units within an address range of the corresponding layer and sequentially outputting reference numbers of neurons, connected to input synapses of neurons within the corresponding layer, to data outputs of the first memory
b2. The process of sequentially outputting output values of the neurons, connected to the input synapses of the neurons within the corresponding layer, to data outputs of the read ports of the second memory of the plurality of memory units
b3. The process of sequentially calculating, by the calculation sub-system, new output values of all the neurons within the corresponding layer
b4. The process of sequentially storing, by the calculation sub-system, the calculated output values of the neurons through the write ports of the second memory of the plurality of memory units

6. (canceled)

7. The neural network computing device of claim 1, wherein the dual port memory comprises physical dual port memory having a logic circuit capable of simultaneously accessing one piece of memory in an identical clock cycle.

8. The neural network computing device of claim 1, wherein the dual port memory comprises two input/output ports accessing one piece of memory in different clock cycles in a time-division way.

9. The neural network computing device of claim 1, wherein the dual port memory comprises:
two pieces of identical physical memory, and
a dual memory swap circuit for changing and connecting all inputs and outputs of the two pieces of identical physical memory using a plurality of switches controlled in response to a control signal from the control unit.

10. The neural network computing device of claim 1, wherein the calculation sub-system comprises:
a plurality of synapse units for receiving outputs of the plurality of memory units, respectively, and performing synapse-specific calculation;
a dendrite unit for receiving outputs of the plurality of synapse units and calculating a sum of inputs transferred from all synapses of a neuron; and
a soma unit for receiving an output of the dendrite unit, updating a state value of the neuron, and calculating a new output value, or
the plurality of synapse units; and
the soma unit.

11-12. (canceled)

13. The neural network computing device of claim 1, wherein the calculation sub-system comprises:
state value memory for storing a state value; and
one or more calculation circuits for sequentially calculating new state values using data sequentially read from an output of the state value memory as some or all of inputs and sequentially storing some or all of results of the calculation in the state value memory.

14. (canceled)

15. The neural network computing device of claim 1, wherein the calculation sub-system comprises:
look-up memory for storing a plurality of attribute values and providing the attribute values to the calculation circuit; and
one or more pieces of attribute value reference number memory for storing a plurality of attribute value reference numbers and providing the attribute value reference numbers to the look-up memory.

16-27. (canceled)

28. The neural network computing device of claim 1, wherein each of the plurality of memory units comprises:
first memory for storing a reference number of a neuron connected to a synapse;
second memory comprising the dual port memory having a read port and a write port;
third memory comprising the dual port memory having a read port and a write port; and
a dual memory swap circuit comprising a plurality of switches which is controlled in response to a control signal from the control unit and which changes and connects all inputs and outputs of the second memory and the third memory.

29-30. (canceled)

31. The neural network computing device of claim 1, wherein each of the plurality of memory units comprises:
first memory for storing a reference number of a neuron connected to a synapse;
second memory comprising the dual port memory having a read port and a write port;
third memory comprising the dual port memory having a read port and a write port;
fourth memory comprising the dual port memory having a read port and a write port; and
triple memory swap circuit comprising a plurality of switches which is controlled in response to a control signal from the control unit and which sequentially changes and connects all inputs and outputs of the second memory to the fourth memory.

32-40. (canceled)

41. The neural network computing device of claim 1, further comprising an offset circuit for enabling the control unit to easily change an access range of memory to an address input stage of each of the memory unit or one a plurality of pieces of memory within the calculation sub-system by designating a value obtained by adding a designated offset value to an accessed address value as an address of the memory.

42. The neural network computing device of claim 1, wherein the control unit comprises a Stage Operation Table (SOT) comprising information required to generate a control signal for each control step, reads records of the SOT one by one for each control step, and uses the read records in a system operation.

43. (canceled)

44. A neural network computing system, comprising:
a control unit for controlling the neural network computing system;
a plurality of network sub-systems each comprising a plurality of memory units each for outputting an output value of a pre-synaptic neuron using dual port memory; and
a plurality of calculation sub-systems each for calculating an output value of a new post-synaptic neuron using the output values of the pre-synaptic neurons received from a plurality of the memory units included in one of the plurality of network sub-systems and feeding the new output value back to each of the plurality of memory units.

45. The neural network computing system of claim 44, further comprising a multiplexer which is provided between an output stage of the plurality of calculation sub-systems and an input stage to which feedback inputs of the plurality of memory units of the plurality of network sub-systems are connected in common and which multiplexes outputs of the plurality of calculation sub-systems.

46. The neural network computing system of claim 44, wherein the control unit generates control signals having a time lag and varying in identical order using a plurality of shift registers connected in a row and supplies the control signals to address inputs of memory within the neural network computing system.

47-51. (canceled)

52. A memory device, comprising:
first memory for storing a reference number of a pre-synaptic neuron; and
second memory comprising dual port memory having a read port and a write port, for storing an output value of a neuron.

53. The memory device of claim 52, wherein the dual port memory comprises physical dual port memory having a logic circuit capable of simultaneously accessing one piece of memory in an identical clock cycle.

54. The memory device of claim 52, wherein the dual port memory comprises two input/output ports accessing one piece of memory in different clock cycles in a time-division way.

55. The memory device of claim 52, wherein:
the dual port memory comprises two pieces of identical physical memory, and
a dual memory swap circuit for changing and connecting all inputs and outputs of the two pieces of identical physical memory using a plurality of switches controlled in response to a control signal from a control unit.

56. (canceled)
